(19) United States
(12) Patent Application Publication
(10) Pub. No.: US 2019/0030873 A1
(43) Pub. Date: Jan. 31, 2019

(54) AEROGEL LAMINATE AND THERMAL INSULATION MATERIAL

(71) Applicant: HITACHI CHEMICAL COMPANY, LTD., Tokyo (JP)

(72) Inventors: Satoshi TAKAYASU, Chiyoda-ku, Tokyo (JP); Tomohiko KOTAKE, Chiyoda-ku, Tokyo (JP); Masato MIYATAKE, Chiyoda-ku, Tokyo (JP); Tatsuya MAKINO, Chiyoda-ku, Tokyo (JP); Kaito KOGURE, Chiyoda-ku, Tokyo (JP); Harumi NEGISHI, Chiyoda-ku, Tokyo (JP); Yasushi OOYAMA, Chiyoda-ku, Tokyo (JP)

(21) Appl. No.: 16/077,877

(22) PCT Filed: Jan. 24, 2017
(86) PCT No.: PCT/JP2017/002353

§ 371 Date: Aug. 14, 2018

(30) Foreign Application Priority Data
Feb. 15, 2016 (JP) 2016-025570

(51) Int. Cl. B32B 27/28; B32B 9/00; B32B 15/08; B32B 27/20; F16L 59/04

(52) U.S. Cl. CPC B32B 27/283; B32B 9/007; B32B 2307/304; B32B 27/20; F16L 59/04; B32B 15/08

(57) ABSTRACT

The present invention relates to an aerogel laminate having a structure in which a resin layer, a substrate and an aerogel layer are laminated in this order.

### TECHNICAL FIELD

The present invention relates to an aerogel laminate and a thermal insulation material.

### BACKGROUND ART

Recently, requirements for comfortability of living spaces and energy saving have been increasing; for this reason, the shapes of target objects required for thermal insulation properties tend to become complex, and the spaces for disposing thermal insulation materials tend to be reduced. For this reason, a thermal insulation material having not only enhanced thermal insulation performance but also a lower thickness has been required.

As an attempt for an enhancement in thermal insulation performance of a thermal insulation material using a foamed resin, for example, a plate-like foamed body containing at least one layer of metal thin film on the surface or the inside of a polypropylene-based resin foamed body has been proposed in Patent Literature 1.

Moreover, cryogenic substances such as liquid nitrogen and liquid helium are stored in containers having a double-walled structure composed of an internal container and an external container; the space between the internal container and the external container is in vacuum, and is filled with a thermal insulation material. As a thermal insulation material filled into such a vacuum space, for example, a laminated thermal insulation material in which a reflective film having a metal layer formed on one or both surfaces of a polyimide film and a net-like spacer composed of plastic yarns are laminated is disclosed in Patent Literature 2. Moreover, a laminated thermal insulation material in which a reflective plate having a metal layer formed on one or both surfaces of a thermoplastic liquid crystal polymer film or inside thereof and a sheet-like spacer composed of thermoplastic polymer fibers are laminated is disclosed in Patent Literature 3.

### CITATION LIST

### Patent Literature

Patent Literature 1: JP 2001-179866 A
Patent Literature 2: JP 09-109323 A
Patent Literature 3: JP 2000-266282 A

### SUMMARY OF INVENTION

### Technical Problem

However, in the case of the thermal insulation material using a resin foamed body, the foamed body needs to be thick to obtain good thermal insulation performance; a reduction in thickness of the thermal insulation layer is difficult. Moreover, the thermal insulation materials used in the fields of cryogenic techniques and superconductive techniques needing the cryogenic substances have been required for a further enhancement in thermal insulation performance while the thickness is reduced. On the other hand, aerogels are known as a material that has a small thermal conductivity and thermal insulation properties, and the form of an aerogel laminate in which a thin film of an aerogel layer is formed on a substrate may be employed. When storing the aerogel laminate in a roll shape or using it with two or more layers laminated, a part of the aerogel layer may be transferred to the surface of the overlapping substrate on which no aerogel layer is formed (hereinafter, occasionally referred to as “the rear surface of the substrate”) and may be exfoliated from the substrate.

The present invention has been made in consideration of the circumstances above, and an object of the present invention is to provide an aerogel laminate having superior thermal insulation properties and enabling a reduction in thickness, as well as being able to reduce the transfer of the aerogel layer to the rear surface of the substrate and its exfoliation from the substrate when laminated in plural, and a thermal insulation material including the aerogel laminate.

### Solution to Problem

The present inventors provide an aerogel laminate having a structure in which a resin layer, a substrate and an aerogel layer are laminated in this order.

The aerogel laminate described above can reduce the transfer of the aerogel layer to the rear surface of the substrate and its exfoliation from the substrate by providing a resin layer onto the rear surface of the substrate, and a reduction in thickness of the laminate is also enabled.

The resin layer described above includes at least one resin selected from the group consisting of a silicone resin, a fluorine resin, a polyolefin resin, an alkyd resin, a long chain alkyl-containing resin and a siloxane modified resin. By this means, it becomes possible to further prevent the aerogel layer from being attached and transferred to the resin layer or being exfoliated from the substrate, and superior thermal insulation properties of the aerogel laminate can be attained.

From the viewpoint of enhancing the thermal insulation properties of the aerogel laminate, the substrate described above may have a heat ray reflective function or a heat ray absorbing function.

The above aerogel layer may be a layer containing an aerogel having a structure derived from polysiloxane. Thereby, the thickness of the aerogel layer can be reduced, and an effect of enhancing the thermal insulation properties of the aerogel laminate is more readily developed.

Moreover, the above aerogel layer may be a layer composed of a dry product of a wet gel that is a condensation product of a sol containing at least one selected from the group consisting of a silicon compound having a hydrolyzable functional group or a condensable functional group, and a hydrolysis product of the silicon compound having a hydrolyzable functional group. The aerogel laminate thus obtained has a superior balance between the thermal insulation properties and the flexibility.

Furthermore, the above sol may further contain silica particles. Thereby, higher thermal insulation properties and flexibility of the aerogel layer can be attained.

The average primary particle diameter of the above silica particles can be 1 to 500 nm. Thereby, the thermal insulation properties and the flexibility of the aerogel layer are more readily enhanced.

The above substrate can have a layer composed of a material containing at least one selected from the group consisting of carbon graphite, aluminum, magnesium, silver, titanium, carbon black, metal sulfates, and antimony compounds. Moreover, if the above substrate is an aluminum foil or an aluminum deposited film, higher thermal insulation properties of the aerogel laminate can be attained.

Moreover, the present invention can provide a thermal insulation material including the aerogel laminate described above. Such a thermal insulation material has high handling properties, and can develop high thermal insulation performance while the thickness is reduced.

### Advantageous Effects of Invention

According to the present invention, an aerogel laminate having superior thermal insulation properties and enabling a reduction in thickness, as well as being able to reduce the transfer of the aerogel layer to the rear surface of the substrate and its exfoliation from the substrate when laminated in plural, may be provided. A thermal insulation material having such an aerogel laminate has high handling properties, and can develop high thermal insulation performance while the thickness is reduced.

### BRIEF DESCRIPTION OF DRAWINGS

FIG. 1 is a schematic cross-sectional view of the aerogel laminate according to the Embodiment.

FIG. 2 is a schematic cross-sectional view of a multi-layered laminate in which the aerogel laminate according to the Embodiment is laminated.

FIG. 3 is a diagram illustrating a method for calculating a biaxial average primary particle diameter of a particle.

FIG. 4 is a schematic cross-sectional view of a liquid nitrogen container for evaluating thermal insulation properties.

FIG. 5 is a schematic view of a thermal insulation performance tester.

### DESCRIPTION OF EMBODIMENTS

An Embodiment of the present invention will be described below in detail occasionally with reference to a drawing, provided that the present invention be not limited to the following Embodiment.

### Definitions

In this specification, a numerical value range described with “from A to B” refers to the range encompassing the numerical values before and after “to” as the minimum value and the maximum value, respectively. In numerical value ranges described stepwise in this specification, the upper limit value or lower limit value of the step of one numerical value range may be replaced with the upper limit value or lower limit value of the step of another numerical value range. In numerical value ranges described in this specification, the upper limit value or lower limit value of the numerical value ranges may be replaced with the values shown in the Example. “A or B” may include any one of A and B, or may include both. Materials exemplified in the Embodiment, unless otherwise stated, may be used singly, or in a combination of 2 or more thereof. In this specification, the content of each ingredient in the composition, unless otherwise stated, means the total amount of a plurality of substances present in the composition when there are a plurality of substances corresponding to respective ingredients in the composition. By “room temperature”, 25° C. is meant.

[Aerogel Laminate]

An aerogel laminate according to the Embodiment has a structure in which a resin layer, a substrate and an aerogel layer are laminated in this order. By providing a resin layer onto the substrate, the transfer of the aerogel layer to the rear surface of the substrate and its exfoliation from the substrate, which take place when a plurality of aerogel laminates are stacked, may be reduced. The aerogel layer has high pliability, which enables the aerogel formed into a sheet, which was conventionally difficult with respect to handling properties; such an aerogel can be integrated with the substrate; for this reason, in the case where the aerogel laminate is used as a thermal insulation material, the thickness of the thermal insulation layer can be reduced. The substrate having a heat ray reflective function or a heat ray absorbing function, which is a non-aerogel layer, functions as a radiating body, and can play a role in blocking external heat. In addition, by laminating the aerogel layer onto a thermally non-conductive substrate, increase in temperature through thermal conduction is prevented.

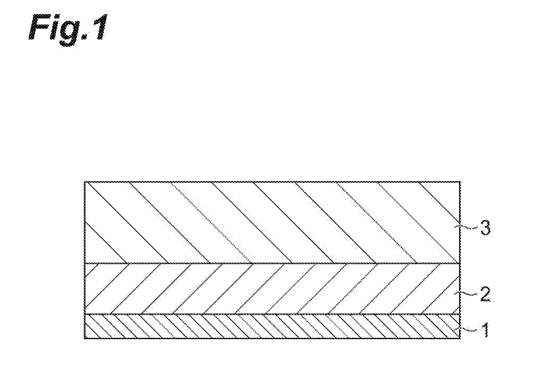

FIG. 1 is a diagram schematically illustrating a cross-section of the aerogel laminate according to the Embodiment. As illustrated in FIG. 1, the aerogel laminate has a structure in which resin layer 1, substrate 2 and aerogel layer 3 are laminated in this order. By giving one or more structures described above to the aerogel laminate, a reduction in thickness can be achieved to obtain an aerogel laminate having high thermal insulation properties and flexibility.

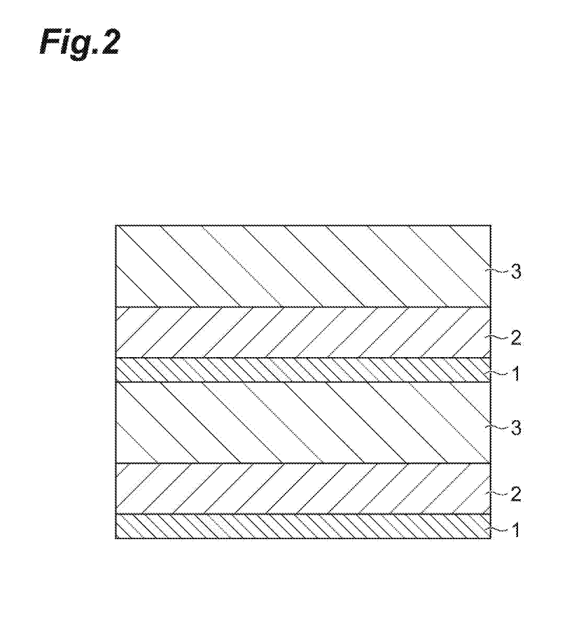

FIG. 2 is a diagram schematically illustrating a cross-section of a multi-layered laminate in which a plurality of the aerogel laminates according to the Embodiment are laminated. As illustrated in FIG. 2, the aerogel laminate according to the Embodiment can be formed into a multi-layered laminate in which a plurality of resin layers 1, substrates 2 and aerogel layers 3 are alternately laminated. The multi-layered laminate may have 5 layers or more, 10 layers or more, or 20 layers or more as long as the aerogel layer is laminated so that resin layers 1 do not directly contact each other.

By disposing a multi-layered structure in which resin layer 1, substrate 2 and aerogel layer 3 are laminated in this order, high thermal insulation performance which cannot be obtained in a single-layer aerogel laminate can be developed.

<Aerogel Layer>

The aerogel layer according to the Embodiment is a layer composed of an aerogel. In a narrow sense, a dried gel obtained by a supercritical drying method from a wet gel is called as aerogel, a dried gel obtained by drying at the atmospheric pressure therefrom is called as xerogel, and a dried gel obtained by freeze-drying therefrom is called as cryogel, however in this Embodiment a low density dried gel obtained from a wet gel without using the above drying techniques is called as aerogel. In other words, aerogel in the Embodiment means aerogel in a broad sense, namely “Gel comprised of a microporous solid in which the dispersed phase is a gas”. Generally the inside of an aerogel is configured as a networked microstructure, having a cluster structure in which approx. 2 to 20-nm aerogel particles (particles composing the aerogel) are bonded together. There are pores in a size less than 100 nm among skeletons formed by the clusters. Thereby, the aerogel constitutes a three-dimensional microporous structure. In this regard, an aerogel according to the Embodiment is a silica aerogel containing silica as a main component. Examples of a silica aerogel include a so-called organic-inorganic hybridized silica aerogel, in which an organic group (such as a methyl group), or an organic chain is introduced. The aerogel layer according to the Embodiment may be a layer containing an aerogel having a structure derived from polysiloxane.

The aerogel according to the Embodiment may be a dry product of a wet gel that is a condensation product of a sol containing at least one selected from the group consisting of a silicon compound having a hydrolyzable functional group or a condensable functional group (in the molecule), and a hydrolysis product of the silicon compound having a hydrolyzable functional group. Namely, the aerogel layer according to the Embodiment may be obtained by drying a wet gel formed from a sol containing at least one selected from the group consisting of a silicon compound having a hydrolyzable functional group or a condensable functional group (in the molecule), and a hydrolysis product of the silicon compound having a hydrolyzable functional group. By using these modes, the thermal insulation properties and flexibility of the aerogel layer are further enhanced. The condensation product may be obtained through the condensation reaction of a hydrolysis product obtained by the hydrolysis of the silicon compound having a hydrolyzable functional group, or through the condensation reaction of the silicon compound having a condensable functional group that is not a functional group obtained by the hydrolysis. The silicon compound may have at least one of a hydrolyzable functional group and a condensable functional group, or both of the hydrolyzable functional group and the condensable functional group. As described above, it should be noted that each aerogel described later may be a dry product of a wet gel that is a condensation product of a sol containing at least one selected from the group consisting of a silicon compound having a hydrolyzable functional group or a condensable functional group, and a hydrolysis product of the silicon compound having a hydrolyzable functional group (it may be obtained by drying the wet gel formed from the sol).

The aerogel layer may be a layer composed of a dry product of a wet gel that is a condensation product of a sol containing at least one selected from the group consisting of a silicon compound having a hydrolyzable functional group or a condensable functional group, and a hydrolysis product of the silicon compound having a hydrolyzable functional group. Namely, the aerogel layer may be composed of a layer prepared by drying a wet gel formed from a sol containing at least one selected from the group consisting of a silicon compound having a hydrolyzable functional group or a condensable functional group, and a hydrolysis product of the silicon compound having a hydrolyzable functional group.

The aerogel according to the Embodiment may contain polysiloxane having the main chain comprising a siloxane bond (Si—O—Si). The aerogel may have, as structural units, M, D, T or Q units described below.

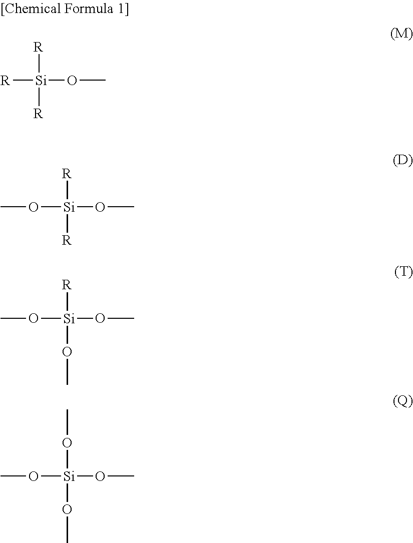

In the above formula, R represents an atom (such as, hydrogen atom) or an atomic group (such as, alkyl group) bonded to the silicon atom. The M unit is a unit composed of a monovalent group in which the silicon atom bonds to one oxygen atom. The D unit is a unit composed of a divalent group in which the silicon atom bonds to two oxygen atoms. The T unit is a unit composed of a trivalent group in which the silicon atom bonds to three oxygen atoms. The Q unit is a unit composed of a quadrivalent group in which the silicon atom bonds to four oxygen atoms. The information regarding the contents of these units can be obtained through Si-NMR.

The aerogel according to the Embodiment may contain silsesquioxane. Silsesquioxane is polysiloxane having the above T units as the structural unit, and has the compositional formula: (RSiO_{1.5})ₙ. Silsesquioxane may have a variety of skeleton structures, such as a cage type, a ladder type, or a random type.

Examples of the hydrolyzable functional group include alkoxy groups. Examples of the condensable functional group (excluding a functional group corresponding to a hydrolyzable functional group) include a hydroxyl group, silanol group, carboxyl group and phenolic hydroxyl group. The hydroxyl group may be comprised in a hydroxyl group-containing group, such as hydroxyalkyl groups. Each of the hydrolyzable functional group and condensable functional group may be used singly, or in a combination of 2 or more thereof.

The silicon compound can include a silicon compound having an alkoxy group as a hydrolyzable functional group, and a silicon compound having a hydroxyalkyl group as a condensable functional group. The silicon compound may have, from the viewpoint of further enhancing the flexibility of the aerogel, at least one selected from the group consisting of an alkoxy group, a silanol group, a hydroxyalkyl group and a polyether group. The silicon compound may have, from the viewpoint of enhancing the compatibility of the sol, at least one selected from the group consisting of an alkoxy group and a hydroxyalkyl group.

From the viewpoint of enhancement of the reactivity of the silicon compound and reduction of the thermal conductivity coefficient of the aerogel, each carbon number of an alkoxy group and a hydroxyalkyl group may be 1 to 6; however from the viewpoint of improving further the flexibility of the aerogel, it may be also 2 to 4. Examples of the alkoxy group include a methoxy group, an ethoxy group, and a propoxy group. Examples of the hydroxyalkyl group include a hydroxymethyl group, a hydroxyethyl group, and a hydroxypropyl group.

Examples of the aerogel according to the Embodiment include the following modes. By using these modes, it is easy to obtain an aerogel having further high thermal insulation properties and high flexibility and enabling formation of a thin film. By using each of the modes, an aerogel having thermal insulation properties and flexibility and enabling formation of a thin film according to each of the modes can be obtained.

(First Mode)

The aerogel according to the Embodiment may be a dry product of a wet gel that is a condensation product of a sol containing at least one compound (hereinafter, occasionally referred to as a “polysiloxane compound group”) selected from the group consisting of a polysiloxane compound having a hydrolyzable functional group or a condensable functional group (in the molecule), and a hydrolysis product of the polysiloxane compound having a hydrolyzable functional group (the polysiloxane compound in which the hydrolyzable functional group has been hydrolyzed). Namely, the aerogel according to the Embodiment may be obtained by drying a wet gel formed from a sol containing at least one selected from the group consisting of a polysiloxane compound having a hydrolyzable functional group or a condensable functional group (in the molecule), and a hydrolysis product of the polysiloxane compound having a hydrolyzable functional group. As described above, it should be noted that each aerogel described later may also be a dry product of a wet gel that is a condensation product of a sol containing at least one selected from the group consisting of a polysiloxane compound having a hydrolyzable functional group or a condensable functional group, and a hydrolysis product of the polysiloxane compound having a hydrolyzable functional group (it may be obtained by drying the wet gel formed from the sol).

The aerogel layer may be a layer composed of a dry product of a wet gel that is a condensation product of a sol containing at least one selected from the group consisting of a polysiloxane compound having a hydrolyzable functional group or a condensable functional group, and a hydrolysis product of the polysiloxane compound having a hydrolyzable functional group. Namely, the aerogel layer may be composed of a layer prepared by drying a wet gel formed from a sol containing at least one selected from the group consisting of a polysiloxane compound having a hydrolyzable functional group or a condensable functional group, and a hydrolysis product of the polysiloxane compound having a hydrolyzable functional group. The aerogel laminate thus obtained has a superior balance between the thermal insulation properties and the flexibility.

Furthermore, the polysiloxane compound having a hydrolyzable functional group or a condensable functional group may have a reactive group different from a hydrolyzable functional group and a condensable functional group (a functional group not corresponding to a hydrolyzable functional group and a condensable functional group). Examples of the reactive group include, but should not be particularly limited to, an epoxy group, a mercapto group, a glycidoxy group, a vinyl group, an acryloyl group, a methacryloyl group, and an amino group. The epoxy group may be comprised in an epoxy group-containing group, such as a glycidoxy group. Polysiloxane compounds having the reactive group may be used singly, or in a combination of 2 or more thereof.

From the viewpoint of enhancing the flexibility of the aerogel, examples of the functional group include an alkoxy group, a silanol group, a hydroxyalkyl group and a polyether group. From the viewpoint of enhancing the compatibility of the sol, examples of the functional group include an alkoxy group and a hydroxyalkyl group. From the viewpoint of enhancement of the reactivity of the polysiloxane compound and reduction of the thermal conductivity coefficient of the aerogel, the number of carbon atoms of an alkoxy group and a hydroxyalkyl group may be 1 to 6; however, from the viewpoint of further enhancing the flexibility of the aerogel, it may be also 2 to 4.

Examples of a polysiloxane compound having a hydroxyalkyl group include compound having a structure expressed by the following Formula (A).

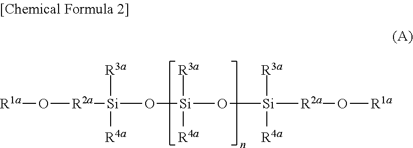

In Formula (A), R^{1a} represents a hydroxyalkyl group, R^{2a} represents an alkylene group, R^{3a} and R^{4a} each independently represent an alkyl group or an aryl group, and n represents an integer of 1 to 50. In this case, examples of an aryl group include a phenyl group, and a substituted phenyl group. Examples of a substituent of the substituted phenyl group include an alkyl group, a vinyl group, a mercapto group, an amino group, a nitro group, and a cyano group. In Formula (A), 2 R^{1a} may be respectively the same or different, and similarly R^{2a} may be respectively the same or different. In Formula (A), 2 or more R^{3a} may be respectively the same or different, and similarly 2 or more R^{4a} may be respectively the same or different.

When a wet gel that is a condensation product of a sol containing a polysiloxane compound having the above structure (the wet gel formed from the sol) is used, an aerogel which has a low thermal conductivity coefficient and is flexible can be obtained further easily. From a similar viewpoint, characteristics shown below may be satisfied. Examples of R^{1a} in Formula (A) include C1 to C6 hydroxyalkyl groups; and examples thereof specifically include a hydroxyethyl group and a hydroxypropyl group. Examples of R^{2a} in Formula (A) include C1 to C6 alkylene groups; and examples thereof specifically include an ethylene group and a propylene group. In Formula (A), R^{3a} and R^{4a} may be each independently a C1 to C6 alkyl group or a phenyl group. The alkyl group may be a methyl group. In Formula (A), n may be 2 to 30, or may be also 5 to 20.

For a polysiloxane compound having a structure expressed by Formula (A), a commercial product may be used, and examples thereof include compounds, such as X-22-160AS, KF-6001, KF-6002, and KF-6003 (all produced by Shin-Etsu Chemical Co., Ltd.), and compounds, such as XF42-B0970, and Fluid OFOH 702-4% (all produced by Momentive Performance Materials Inc.).

Examples of a polysiloxane compound having an alkoxy group include those having a structure expressed by the following Formula (B).

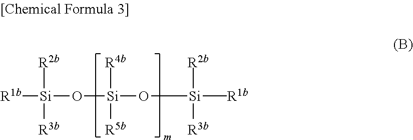

In Formula (B), R^{1b} represents an alkyl group, an alkoxy group or an aryl group, R^{2b} and R^{3b} each independently represent an alkoxy group, R^{4b} and R^{5b} each independently represent an alkyl group or an aryl group, and in represents an integer of 1 to 50. In this case, examples of an aryl group include a phenyl group, and a substituted phenyl group. Examples of a substituent of a substituted phenyl group include an alkyl group, a vinyl group, a mercapto group, an amino group, a nitro group, and a cyano group. Meanwhile, in Formula (B), 2 R^{1b} may be respectively the same or different, 2 R^{2b} may be respectively the same or different, and similarly 2 R^{3b} may be respectively the same or different. In Formula (B), in a case where in is an integer of 2 or higher, 2 or more R^{4b} may be respectively the same or different, and similarly 2 or more R^{5b} may be respectively the same or different.

When a wet gel that is a condensation product of a sol containing a polysiloxane compound having the above structure or a hydrolysis product thereof (the wet gel formed from the sol) is used, an aerogel which has a low thermal conductivity coefficient and is flexible can be obtained further easily. From a similar viewpoint, characteristics shown below may be satisfied. Examples of R^{1b} in Formula (B) include C1 to C6 alkyl groups and C1 to C6 alkoxy groups; and examples thereof specifically include a methyl group, a methoxy group and an ethoxy group. In Formula (B), R^{2b} and R^{3b} may be each independently a C1 to C6 alkoxy group. Examples of the alkoxy group include a methoxy group and an ethoxy group. In Formula (B), R^{4b} and R^{5b} may be each independently a C1 to C6 alkyl group or a phenyl group. The alkyl group may be a methyl group. In Formula (B), in may be 2 to 30, or may be also 5 to 20.

A polysiloxane compound having a structure expressed by Formula (B) may be obtained for example referring appropriately to production methods reported in JP 2000-26609 A, JP 2012-233110 A, etc.

Since an alkoxy group is hydrolyzable, it is possible that a polysiloxane compound having an alkoxy group exists in a sol as a hydrolysis product, therefore a polysiloxane compound having an alkoxy group and a hydrolysis product thereof may coexist. Further, in a polysiloxane compound having an alkoxy group, all of the alkoxy groups in the molecule may be hydrolyzed, or only part of them may be hydrolyzed.

Each of the polysiloxane compound having a hydrolyzable functional group or a condensable functional group, and a hydrolysis product of the polysiloxane compound having a hydrolyzable functional group may be used singly, or in a combination of 2 or more thereof.

Because good reactivity is more readily obtained, the content of the polysiloxane compound group contained in the above sol (the total sum of the content of the polysiloxane compound having a hydrolyzable functional group or a condensable functional group, and the content of a hydrolysis product of the polysiloxane compound having a hydrolyzable functional group) may be 1 part by mass or more, 3 parts by mass or more, 5 parts by mass or more, or 10 parts by mass or more relative to the total amount of 100 parts by mass of the sol. Because good compatibility is more readily obtained, the content of the polysiloxane compound group may be 50 parts by mass or less, 30 parts by mass or less, or 15 parts by mass or less relative to the total amount of 100 parts by mass of the sol. Namely, the content of the polysiloxane compound and a hydrolysis product of the polysiloxane compound may be 5 to 50 parts by mass, 10 to 30 parts by mass, or 10 to 15 parts by mass relative to the total amount of 100 parts by mass of the sol.

(Second Mode)

As a silicon compound having a hydrolyzable functional group or a condensable functional group, silicon compounds other than the polysiloxane compound may be used. Namely, the aerogel according to the Embodiment may be a dry product of a wet gel that is a condensation product of a sol containing at least one compound (hereinafter, occasionally referred to as a “silicon compound group”) selected from the group consisting of a silicon compound having a hydrolyzable functional group or a condensable functional group (in the molecule) (excluding a polysiloxane compound), and a hydrolysis product of the silicon compound having a hydrolyzable functional group. The number of silicon atoms in the molecule of the silicon compound can be 1 or 2.

Upon producing the aerogel according to the Embodiment, a sol containing the polysiloxane compound group described above may further contain a silicon compound group.

Examples of the silicon compound having a hydrolyzable functional group include, but should not be particularly limited to, alkyl silicon alkoxides. In these alkyl silicon alkoxides, the number of the hydrolyzable functional groups may be 3 or less, or 2 to 3 from the viewpoint of improving the water resistance. Examples of the alkyl silicon alkoxides include monoalkyltrialkoxysilanes, monoalkyldialkoxysilanes, dialkyldialkoxysilanes, monoalkylmonoalkoxysilanes, dialkylmonoalkoxysilanes, and trialkylmonoalkoxysilanes. Examples of the alkyl silicon alkoxides include methyltrimethoxysilane, methyldimethoxysilane, dimethyldimethoxysilane, and ethyltrimethoxysilane.

Examples of the silicon compound having a condensable functional group include, but should not be particularly limited to, silanetetraol, methylsilanetriol, dimethylsilanediol, phenylsilanetriol, phenylmethylsilanediol, diphenylsilanediol, n-propylsilanetriol, hexylsilanetriol, octylsilanetriol, decylsilanetriol, and trifluoropropylsilanetriol.

As silicon compounds having 3 or less hydrolyzable functional groups as well as a reactive group, vinyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, 3-acryloxypropyltrimethoxysilane, 3-mercaptopropyltrimethoxysilane, 3-mercaptopropylmethyldimethoxysilane, N-phenyl-3-aminopropyltrimethoxysilane, N-2-(aminoethyl)-3-aminopropylmethyldimethoxysilane and the like may be also used.

Further, as a silicon compound having a condensable functional group and having the previously mentioned reactive group, vinylsilanetriol, 3-glycidoxypropylsilanetriol, 3-glycidoxypropylmethylsilanediol, 3-methacryloxypropylsilanetriol, 3-methacryloxypropylmethylsilanediol, 3-acryloxypropylsilanetriol, 3-mercaptopropylsilanetriol, 3-mercaptopropylmethylsilanediol, N-phenyl-3-aminopropylsilanetriol, N-2-(aminoethyl)-3-aminopropylmethylsilanediol and the like may also be used.

As silicon compounds having 3 or less hydrolyzable functional groups at a molecular terminal, bis(trimethoxysilyl)methane, bis(trimethoxysilyl)ethane, bis(trimethoxysilyl)hexane and the like may be also used.

Each of the silicon compound having a hydrolyzable functional group or a condensable functional group (excluding a polysiloxane compound), and a hydrolysis product of the silicon compound having a hydrolyzable functional group may be used singly, or in a combination of 2 or more thereof.

Because good reactivity is more readily obtained, the content of the silicon compound group contained in the above sol (the total sum of the content of the silicon compound having a hydrolyzable functional group or a condensable functional group (excluding a polysiloxane compound), and the content of a hydrolysis product of the silicon compound having a hydrolyzable functional group) may be 5 part by mass or more, 10 parts by mass or more, or 15 parts by mass or more relative to the total amount of 100 parts by mass of the sol. Because good compatibility is more readily obtained, the content of the silicon compound group may be 50 parts by mass or less, 30 parts by mass or less, or 25 parts by mass or less relative to the total amount of 100 parts by mass of the sol. Namely, the content of the silicon compound group may be 5 to 50 parts by mass, 10 to 30 parts by mass, or 15 to 25 parts by mass relative to the total amount of 100 parts by mass of the sol.

Because good reactivity is more readily obtained, the total sum of the content of the polysiloxane compound group and the content of the silicon compound group may be 5 parts by mass or more, 10 parts by mass or more, 15 parts by mass or more, or 20 parts by mass or more relative to the total amount of 100 parts by mass of the sol. Because good compatibility is more readily obtained, the total sum of the contents may be 50 parts by mass or less, 30 parts by mass or less, or 25 parts by mass or less relative to the total amount of 100 parts by mass of the sol. Namely, the total sum of the contents may be 5 to 50 parts by mass, 10 to 30 parts by mass, 15 to 30 parts by mass, or 20 to 25 parts by mass relative to the total amount of 100 parts by mass of the sol.

The ratio of the content of the polysiloxane compound group to the content of the silicon compound group (polysiloxane compound group:silicon compound group) may be 1:0.5 to 1:4, 1:1 to 1:2, 1:2 to 1:4, or 1:3 to 1:4. Better compatibility is more readily obtained if the ratio of the contents of these compounds is 1:0.5 or more. The contraction of the gel is more readily suppressed if the above ratio of the contents is 1:4 or less.

(Third Mode)

An aerogel according to the Embodiment may have a structure expressed by the following Formula (1). An aerogel according to the Embodiment may have a structure expressed by the following Formula (1a) as a structure including the structure expressed by Formula (1). A structure expressed by Formula (1) and Formula (1a) may be introduced into the skeleton of an aerogel by using a polysiloxane compound having a structure expressed by the above Formula (A).

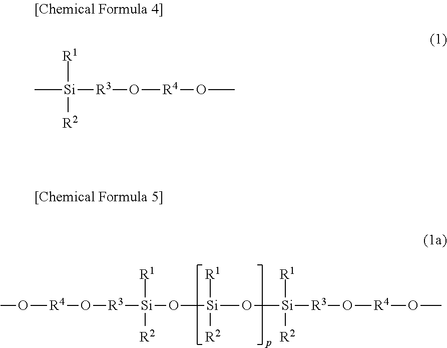

In Formula (1) and Formula (1a), R¹ and R² each independently represent an alkyl group or an aryl group, and R³ and R⁴ each independently represent an alkylene group. In this case, examples of an aryl group include a phenyl group, and a substituted phenyl group. Examples of a substituent of a substituted phenyl group include an alkyl group, a vinyl group, a mercapto group, an amino group, a nitro group, and a cyano group. p represents an integer of 1 to 50. In Formula (1a), 2 or more R¹ may be respectively the same or different, and similarly, 2 or more R² may be respectively the same or different. In Formula (1a), 2 R³ may be respectively the same or different, and similarly, 2 R⁴ may be respectively the same or different.

When the structure expressed by the above Formula (1) or Formula (1a) is introduced into the skeleton of an aerogel, an aerogel which has a low thermal conductivity coefficient and is flexible may be readily obtained. From a similar viewpoint, characteristics shown below may be satisfied. In Formula (1) and Formula (1a), R¹ and R² may be each independently a C1 to C6 alkyl group or a phenyl group. The alkyl group may be a methyl group. In Formula (1) and Formula (1a), R³ and R⁴ may be each independently a C1 to C6 alkylene group. The alkylene group may be an ethylene group or a propylene group. In Formula (1a), p may be 2 to 30, or may also be 5 to 20.

(Fourth Mode)

The aerogel according to the Embodiment is an aerogel having a ladder structure comprising a strut and a bridge, and may be an aerogel in which a bridge has a structure represented by the following Formula (2). When such a ladder structure is introduced into the skeleton of an aerogel, the heat resistance and the mechanical strength can be improved. A ladder structure comprising a bridge having the structure expressed by Formula (2) may be introduced into the skeleton of an aerogel by using a polysiloxane compound having the structure expressed by the above Formula (B). In this regard, a “ladder structure” in the Embodiment is a structure having 2 struts and bridges connecting the struts together (structure with a so-called “ladder” shape). In the present mode, the skeleton of an aerogel may be configured with a ladder structure, or an aerogel may have a ladder structure only partly.

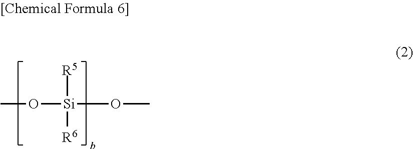

In Formula (2), R⁵ and R⁶ each independently represent an alkyl group or an aryl group, and b represents an integer of 1 to 50. Examples of the aryl group include a phenyl group, and a substituted phenyl group. Examples of a substituent of a substituted phenyl group include an alkyl group, a vinyl group, a mercapto group, an amino group, a nitro group, and a cyano group. Further, in Formula (2), in a case where b is an integer of 2 or higher, 2 or more R⁵ may be respectively the same or different, and similarly 2 or more R⁶ may be respectively the same or different.

When the above structure is introduced into the skeleton of an aerogel, an aerogel having flexibility superior to, for example, an aerogel having a structure originated from a conventional ladder-form silsesquioxane (namely that having a structure expressed by the following Formula (X)) is obtained. In this regard, the structure of a bridge in an aerogel having a structure originated from a conventional ladder-form silsesquioxane is —O— as shown in the following Formula (X), however in an aerogel of the present mode, the structure of a bridge is a structure expressed by the Formula (2) (polysiloxane structure).

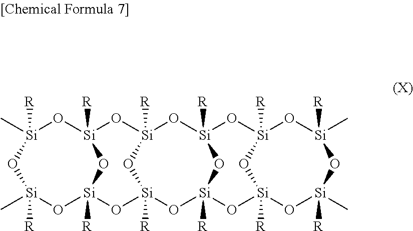

In Formula (X), R represents a hydroxy group, an alkyl group, or an aryl group.

Although there is no particular restriction on the structure to become a strut and the chain length thereof as well as the interval between the structures to become bridges, a ladder structure may have a ladder structure expressed by the following Formula (3) from the viewpoint of improvement of heat resistance and mechanical strength.

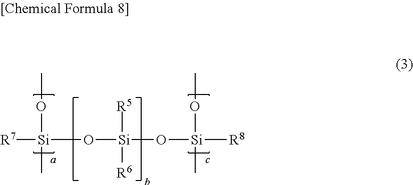

In Formula (3), R⁵, R⁶, R⁷ and R⁸ each independently represent an alkyl group or an aryl group, a and c each independently represent an integer of 1 to 3000, and b represents an integer of 1 to 50. In this case, examples of an aryl group include a phenyl group, and a substituted phenyl group. Examples of a substituent of a substituted phenyl group include an alkyl group, a vinyl group, a mercapto group, an amino group, a nitro group, and a cyano group. In Formula (3), in a case where b is an integer of 2 or higher, 2 or more R⁵ may be respectively the same or different, and similarly 2 or more R⁶ may be respectively the same or different. In Formula (3), in a case where a is an integer of 2 or higher, 2 or more R⁷ may be respectively the same or different, and similarly in a case where c is an integer of 2 or higher, 2 or more R⁸ may be respectively the same or different.

In Formula (2) and Formula (3), R⁵, R⁶, R⁷ and R⁸ (provided that R⁷ and R⁸ are limited to Formula (3)) each independently may be, for example, a C1 to C6 alkyl group, or a phenyl group from the viewpoint of achieving superior flexibility. The alkyl group may be a methyl group. In Formula (3), a and c may be each independently 6 to 2000, or may be also 10 to 1000. In Formula (2) and Formula (3), b may be 2 to 30, or may be also 5 to 20.

(Fifth Mode)

The aerogel according to the Embodiment may contain silica particles. Namely, the sol that provides the aerogel may further contain silica particles. The aerogel according to the Embodiment may be a dry product of a wet gel that is a condensation product of a sol containing silica particles (it may be obtained by drying the wet gel formed from the sol). The aerogel layer may be a layer composed of a dry product of a wet gel that is a condensation product of a sol containing silica particles. Namely, the aerogel layer may be composed of a layer prepared by drying a wet gel formed from a sol containing silica particles. The aerogel layer is a layer in which silica particles are complexed. It should be noted that the aerogel described above may also be a dry product of a wet gel that is a condensation product of a sol containing silica particles (it may be obtained by drying the wet gel formed from the sol) as described above. Thereby, higher thermal insulation properties and flexibility can be attained.

An aerogel containing silica particles according to the Embodiment may have a structure expressed by the following Formula (4).

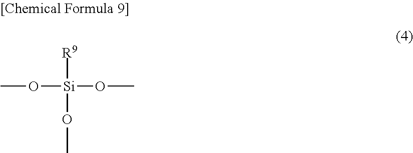

In Formula (4), R⁹ represents an alkyl group. Examples of the alkyl group include a C1 to C6 alkyl group, and examples thereof specifically include a methyl group.

The aerogel containing silica particles according to the Embodiment may have a structure expressed by the following Formula (5).

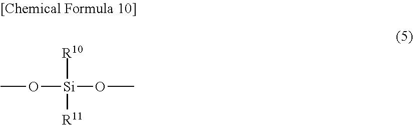

In Formula (5), R¹⁰ and R¹¹ each independently represent an alkyl group. Examples of the alkyl group include a C1 to C6 alkyl group, and examples thereof specifically include a methyl group.

The aerogel containing silica particles according to the Embodiment may have a structure expressed by the following Formula (6).

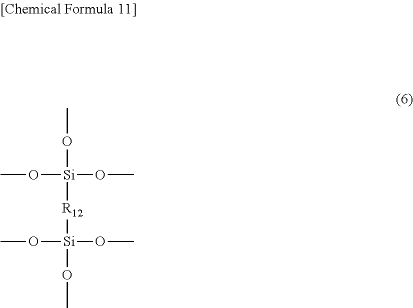

In Formula (6), R¹² represents an alkylene group. Examples of the alkylene group include a C1 to C10 alkylene group, and examples thereof specifically include an ethylene group, and a hexylene group.

The silica particles can be used without limitation in particular, and examples thereof include amorphous silica particles. Examples of the amorphous silica particles include fused silica particles, fumed silica particles, and colloidal silica particles. Among these, colloidal silica particles have high monodispersity to readily suppress the aggregation thereof in the sol.

The shapes of the silica particles are not particularly limited; examples thereof include spherical, cocoon shaped, and associated form. Among these, by using spherical particles as the silica particles, the aggregation thereof in the sol is readily suppressed. The average primary particle diameter of the silica particles can be 1 nm or more, may be 5 nm or more, or may be 10 nm or more because appropriate strength is readily given to the aerogel and an aerogel superior in resistance to contraction during drying is obtained more easily. On the other hand, the average primary particle diameter of the silica particles can be 500 nm or less, may be 300 nm or less, or may be 250 nm or less because the solid heat conduction of the silica particles is readily suppressed and an aerogel having high thermal insulation properties is readily obtained. Namely, the average primary particle diameter of the silica particles can be 1 to 500 nm, may be 5 to 300 nm, or may be 10 to 250 nm.

In the Embodiment, an average primary particle diameter of a silica particle may be obtained by observing directly a cross-section of an aerogel layer using a scanning electron microscope (hereinafter abbreviated as “SEM”). For example, an individual particle diameter of a silica particle may be obtained from a three-dimensional network skeleton based on the diameter of a cross-section thereof. The term “diameter” referred to above means a diameter of a cross-section of a skeleton configuring a three-dimensional network skeleton, wherein the cross-section is deemed as a circle. In this regard, the diameter of a cross-section deemed as a circle means the diameter of a circle having the same area as the area of a cross-section. In determining an average particle diameter, the circle diameters of 100 particles are measured and averaged.

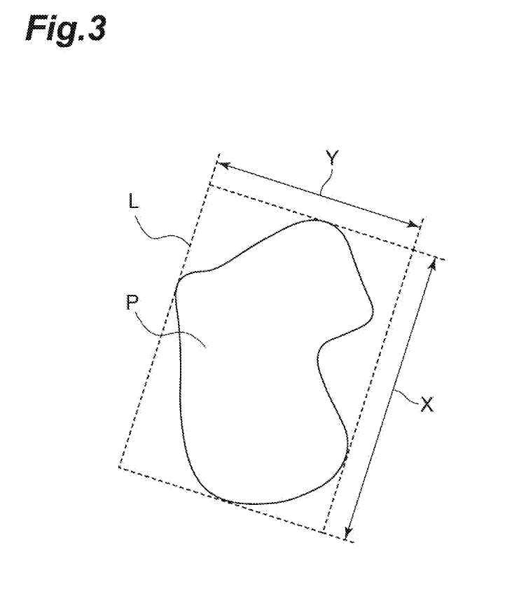

Moreover, the average particle diameter can be measured from the silica particles as a raw material before the aerogel layer is formed. For example, a biaxial average primary particle diameter may be determined from the results of observation of optional 20 particles using a SEM as follows. Namely, taking a colloidal silica particle, which is ordinarily dispersed in water at a solid concentration of 5 to 40 mass %, as an example, a wafer with a pattern wiring is cut to a 2 cm square chip, the chip is dipped in a dispersion of a colloidal silica particle for approx. 30 sec, then rinsed with pure water for approx. 30 sec and dried by a nitrogen blow. Thereafter, the chip is mounted on a sample stage for SEM observation, and a silica particle is observed at a magnification of 100000× by applying an acceleration voltage of 10 kV, and an image is recorded. From the obtained image, 20 silica particles are randomly selected, and an average of the particle diameters of the particles is defined as the average particle diameter. In this case, if a selected silica particle has a shape as shown in FIG. 3, a rectangle, which circumscribes the silica particle P and is placed to have a longest long side (circumscribed rectangle L), is constructed. Putting the long side of the circumscribed rectangle L as X, and the short side as Y, a biaxial average primary particle diameter is calculated as (X+Y)/2, which is defined as the particle diameter of the particle.

Because an aerogel superior in resistance to contraction is obtained more easily, the number of silanol groups per 1 g of silica particles can be 10×10¹⁸/g or more, may be 50×10¹⁸/g or more, or may be 100×10¹⁸/g or more. On the other hand, because a homogeneous aerogel is readily obtained, the number of silanol groups per 1 g of silica particles can be 1000×10¹⁸/g or less, may be 800×10¹⁸/g or less, or may be 700×10¹⁸/g or less. That is, the number of silanol groups per 1 g of silica particles can be from 10×10¹⁸ to 1000×10¹⁸/g, may be from 50×10¹⁸ to 800×10¹⁸/g, or may be from 100×10¹⁸ to 700×10¹⁸/g.

Because appropriate strength is readily given to the aerogel and an aerogel superior in resistance to contraction during drying is obtained more easily, the content of the silica particles contained in the above sol can be 1 part by mass or more, and may be 4 parts by mass or more relative to the total amount of 100 parts by mass of the sol. On the other hand, because the solid heat conduction of the silica particles is readily suppressed and an aerogel having high thermal insulation properties is readily obtained, the content of the silica particles contained in the above sol can be 20 parts by mass or less, 15 parts by mass or less, 12 parts by mass or less, 10 parts by mass or less, or 8 parts by mass or less. Namely, the content of the silica particles may be 1 to 20 parts by mass, 4 to 15 parts by mass, 4 to 12 parts by mass, 4 to 10 parts by mass, or 4 to 8 parts by mass relative to the total amount of 100 parts by mass of the sol.

(Other Modes)

The aerogel according to the Embodiment may have a structure derived from polysiloxane. Examples of the structure derived from polysiloxane include a structure represented by the above Formulae (1), (2), (3), (4), (5) or (6). The aerogel according to the Embodiment may have at least one among the structures represented by the above Formulae (4), (5) and (6) without containing silica particles. Namely, the aerogel layer according to the Embodiment may be composed of a layer containing an aerogel having a structure derived from polysiloxane. Examples of the structure derived from polysiloxane include a structure represented by the above Formulae (1), (2), (3), (4), (5) or (6). Accordingly, the aerogel according to the Embodiment may have at least one among the structures represented by the above Formulae (4), (5) and (6) without containing silica particles.

Because good thermal insulation properties are readily obtained, the thickness of the aerogel layer can be 1 μm or more, may be 10 μm or more, or may be 30 μm or more. On the other hand, from the viewpoint of a reduction in thickness, the thickness of the aerogel layer can be 200 μm or less, may be 100 μm or less, or may be 80 μm or less. Namely, the thickness of the aerogel layer can be 1 to 200 μm, may be 10 to 100 μm, or may be 30 to 80 μm.

From the viewpoint of obtaining higher strength and flexibility, the density at 25° C. of the aerogel layer can be 0.05 g/cm³ or more, may be 0.1 g/cm³ or more, or may be 0.2 g/cm³ or more. On the other hand, from the viewpoint of obtaining higher thermal insulation properties, the density at 25° C. of the aerogel layer can be 0.3 g/cm³ or less, may be 0.25 g/cm³ or less, or may be 0.2 g/cm³ or less. Namely, the density at 25° C. of the aerogel layer can be 0.05 to 0.3 g/cm³, may be 0.1 to 0.25 g/cm³, or may be 0.1 to 0.2 g/cm³.

From the viewpoint of obtaining higher thermal insulation properties, the porosity at 25° C. of the aerogel layer can be 85% or more, or may be 87% or more; from the viewpoint of obtaining higher strength and flexibility, the porosity at 25° C. of the aerogel layer can be 95% or less, or may be 93% or less. Namely, the porosity at 25° C. of the aerogel layer can be 85 to 95%, or may be 87 to 93%.

The density and porosity of the aerogel layer can be measured by mercury intrusion porosimetry according to DIN66133. As a measurement apparatus, AutoPore IV9520 (made by SHIMADZU Corporation, product name) can be used, for example.

### <Resin Layer>

The resin layer according to the Embodiment is a non-aerogel layer, and has adhesiveness to the substrate and releasability to the aerogel layer. The resin layer can be formed using a resin composition, and may be a single layer or may be a multi-layer. As a resin composition, a resin component having good adhesiveness to the substrate while having releasability to the aerogel layer can be included.

The resin layer may include, as a resin component having releasability, at least one resin selected from the group consisting of a silicone resin, a fluorine resin, a polyolefin resin, an alkyd resin, a long chain alkyl group-containing resin and a siloxane modified resin. Because both of the adhesiveness to the substrate and the releasability to the aerogel layer are readily established, it is preferred that the resin layer includes at least one resin selected from the group consisting of a silicone resin, a long chain alkyl group-containing resin and a siloxane modified resin.

Examples of the silicone resin include, but should not be particularly limited to: addition type silicone resins obtained by the addition reaction catalyzed by a platinum-based compound between an alkenyl group-containing polydialkyl siloxane and a polydialkyl hydrogen polysiloxane to cure them; condensation type silicone resins obtained by the reaction using a tin-based catalyst between a methylol group-containing polydialkyl siloxane and a polydialkyl hydrogen polysiloxane; silicone/acrylic graft polymers; and silicone/acrylic block polymers. These silicone resins may be modified.

Examples of the fluorine resin include, but should not be particularly limited to: polytetrafluoroethylene; ethylene-tetrafluoroethylene copolymers; tetrafluoroethylene-perfluoropropylene copolymers; polychlorotrifluoroethylene; polyvinyl fluoride resins; and polyvinylidene fluoride.

Examples of the polyolefin resin include, but should not be particularly limited to: polyethylene, such as high density polyethylene, low density polyethylene, linear low density polyethylene and chlorinated polyethylene; ethylene-α-olefin copolymers, such as ethylene-propylene copolymers, ethylene-butene copolymers, ethylene-octene copolymers, ethylene-propylene-1-butene copolymers and ethylene-propylene terpolymers; ethylene-unsaturated carboxylic acid copolymers, such as ethylene-vinyl acetate copolymers, ethylene-vinyl alcohol copolymers, ethylene-acrylic acid copolymers and ethylene-methacrylic acid copolymers; ethylene-based resins, such as ethylene-ethylene acrylate copolymers, ethylene-methacrylate copolymers, ethylene-ethylene acrylate-maleic anhydride copolymers, and ionomer resins such as metal salts of ethylene-acrylic acid copolymers and metal salts of ethylene-methacrylic acid copolymers; propylene-based resins, such as polypropylene such as isotactic polypropylene, syndiotactic polypropylene and atactic polypropylene, propylene-1-butene copolymers, and propylene-octene copolymers; poly-1-butene; poly-4-methyl-1-pentene; polyisoprene; polyisobutylene; and cyclic olefin copolymers. These polyolefin resins may be modified.

Alkyd resins are a synthetic resin obtained by the condensation reaction between a polyhydric alcohol and a polybasic acid. Examples of the polyhydric alcohol include, but should not be particularly limited to: dihydric alcohols, such as ethylene glycol, propylene glycol and neopentyl glycol; trihydric alcohols, such as glycerin, trimethylolethane and trimethylolpropane; and alcohols with quadrivalence or more, such as diglycerine, pentaerythritol, mannite and sorbit. Examples of the polybasic acid include, but should not be particularly limited to: saturated polybasic acids, such as phthalic anhydride, terephthalic acid, succinic acid and adipic acid; unsaturated polybasic acids, such as maleic acid, maleic anhydride, fumaric acid and isophthalic acid; and polybasic acids via the Diels-Alder reaction of cyclopentadiene-maleic anhydride adducts, terpene-maleic anhydride adducts, and the like. It should be noted that in synthesizing the alkyd resin, benzoic acid may be used in combination.

The long chain alkyl-containing resin is not particularly limited as long as the resin has a long chain alkyl group. Examples of the long chain alkyl-containing resin include long chain alkyl-containing acrylate reactants of polyvinyl alcohol, long chain alkyl-containing methacrylate reactants and long chain alkyl-containing isocyanate reactants of polyvinyl alcohol, long chain alkyl-containing isocyanate reactants of polyethylenimine, and resins in which long chain alkyl groups are introduced via functional groups or the like onto side chains of the polymer chain. Examples of a resin having a long chain alkyl group can include those having alkyl groups having 8 or more carbon atoms, and among others, resins having alkyl groups having 12 to 30 carbon atoms are preferred from the viewpoint of release properties and availability.

Examples of the siloxane modified resin may be, but should not be particularly limited to: polymers obtained by the reaction between various reactive silicone oils having functional groups, such as an amino group, a hydroxy group, a mercapto group, an epoxy group, an isocyanate group, a carboxyl group and a vinyl group, and resins having groups that react with these functional groups; graft copolymers obtained by the reaction of the above both using a crosslinking agent, such as polyisocyanate and polyamine; and graft copolymers obtained by the copolymerization in an appropriate ratio between vinyl modified silicone oils and other monomers having vinyl groups or acryloyl groups.

The resin layer according to the Embodiment may further include other resins different from the resins mentioned above or various additives, as long as they do not inhibit the effects of the present invention.

The resin layer may further include a binder resin as other resins. By this means, the flexibility of the resin layer and its adhesiveness to the substrate are enhanced, and besides, an effect of preventing the aerogel layer from being attached and transferred to the resin layer and being exfoliated from the substrate is more readily developed. A binder resin according to the Embodiment refers to, when properties, such as application properties of the resin composition for forming the resin layer to the substrate, adhesive properties of the resin layer to the substrate, and pliability of the resin layer, are not sufficient, a resin that acts as a component for supporting (complementing) these properties. For example, by using a resin composition containing a binder resin in combination with the above mentioned resin component having releasability, a resin layer having releasability to the aerogel layer while unlikely being exfoliated from the substrate is readily formed. The binder resin can be appropriately selected according to the resin component having releasability.

The binder resin is not particularly limited, and may be a thermoplastic resin, a thermosetting resin or a photocurable resin. Examples of the binder resin include styrene resins, acrylic resins, styrene acrylic resins, vinyl chloride resins, polyester resins, polyamide resins, polyurethane resins, polyvinyl alcohol resins, vinyl ether resins, N-vinyl resins, polyamide resins, styrene-butadiene resins, phenol resins, urea resins, melamine resins, unsaturated polyester resins, allyl resins, epoxy resins, thiourethane resins, furan resins, polyimide resins, sulfonamide resins, aniline resins, cyanate resins, isocyanate resins, polycarbonate resins, ABS resins, polyvinyl acetate resins and cellulose resins. From the viewpoint of adhesive properties to the substrate, as a binder resin, resins containing a nitrogen atom is preferred, and polyurethane resins are more preferred.

Examples of the additive include organic fine particles, inorganic fine particles, crosslinking agents, flame retardants, auxiliary flame retardants, heat resistant stabilizers, oxidation resistant stabilizers, leveling agents, sliding activators, antistatic agents, ultraviolet light absorbers, photostabilizers, nucleating agents, dyes, fillers, dispersing agents and coupling agents.

The thickness of the resin layer is preferably from 1 nm to 5 μm, more preferably from 100 nm to 3 μm, and further preferably from 500 nm to 1 μm. By controlling the thickness of the resin layer to be 1 nm or more, good releasability to the aerogel layer may be obtained, and by controlling it to be 5 μm or less, good thermal insulation performance can be obtained.

<Substrate>

The substrate according to the Embodiment is a non-aerogel layer, and the configuration of the substrate is not particularly limited, and may be a single layer or a multi-layer. The shape of the substrate can be a film shape or foil shape because it can give light-weightness to the aerogel laminate.

When the substrate has at least one layer having a heat ray reflective function or a heat ray absorbing function, the thermal insulation properties of the aerogel laminate can be further enhanced. The substrate having a heat ray reflective function or a heat ray absorbing function serves as a radiating body, and can play a role in blocking external heat.

The heat ray reflective function refers to a function in which reflection of light at about 800 to 3000 nm in the near-infrared or infrared region, for example, is larger than absorption and transmission of the light. In contrast, the heat ray absorbing function refers to a function in which absorption of light at about 800 to 3000 nm in the near-infrared or infrared region, for example, is larger than reflection and transmission of the light. Here, the reflection of light includes scattering of light.

The substrate according to the Embodiment is composed of at least one of a layer having a heat ray reflective function and a layer having a heat ray absorbing function, and may be composed of only the layer having a heat ray reflective function or only the layer having a heat ray absorbing function. Moreover, the substrate may be a laminate of the layer having a heat ray reflective function and the layer having a heat ray absorbing function. Furthermore, the substrate may be a laminate of the heat ray reflective function or layer having a heat ray absorbing function and a layer not having a heat ray reflective function or a heat ray absorbing function. In this case, the layer having a heat ray reflective function or a heat ray absorbing function may be formed one or both surfaces of the layer not having the heat ray reflective function or the heat ray absorbing function.

The layer having a heat ray reflective function can contain a heat ray-reflective material. The heat ray-reflective material is not particularly limited as long as it is a material reflecting light in the near-infrared or infrared region. Examples of the heat ray-reflective material include aluminum compounds such as aluminum and aluminum oxide; zinc compounds such as zinc aluminate; magnesium compounds such as hydrotalcite; silver compounds such as silver; titanium; titanium compounds such as titanium, titanium oxide and strontium titanate; copper compounds such as copper and bronze; stainless steel; nickel; tin; microballoons such as Shirasuballoons; ceramic balloons; and pearl mica. These may be used along or in combination.

Among these, from the viewpoint of readily reducing the thermal conductivity and having low cost and high handling properties, a material containing aluminum, magnesium, silver or titanium can be used as the heat ray-reflective material.

The layer having a heat ray reflective function may be composed of a metal foil such as an aluminum foil or a copper foil. Moreover, the layer having a heat ray reflective function may be a resin film produced by kneading an aluminum paste or titanium oxide with a resin such as polyolefin, polyester, polycarbonate or polyimide. Furthermore, the layer having a heat ray reflective function may be a deposition film in which aluminum or silver is deposited on a resin film of polyolefin, polyester, polycarbonate, polyimide, or the like by physical deposition such as sputtering or vacuum deposition or chemical deposition.

The layer having a heat ray absorbing function can contain a heat ray-absorbing material. The heat ray-absorbing material is not particularly limited as long as it is a substance which absorbs light in the near-infrared or infrared region. Examples of the heat ray-absorbing material include carbon graphite, such as flaky graphite, earthy graphite and artificial graphite, carbon powder, such as carbon black; metal sulfates such as barium sulfate, strontium sulfate, calcium sulfate, mercallite (KHSO₄), halotrichite, alunite, and jarosite; antimony compounds such as antimony trioxide; metal oxides such as tin oxide, indium oxide, indium oxide tin, zinc oxide, and anhydrous zinc antimonate oxide; ammonium-based, urea-based, iminium-based, aminium-based, cyanine-based, polymethine-based, anthraquinone-based, dithiol-based, copper ion-based, phenylenediamine-based, phthalocyanine-based, benzotriazole-based, benzophenone-based, oxanilide-based, cyanoacrylate-based, or benzotriazole-based dyes or pigments.

Among these, a material containing carbon graphite, carbon black, a metal sulfate, or an antimony compound can be used as the heat ray-absorbing material from the viewpoint of readily reducing the thermal conductivity and having low cost and high handling properties. From the viewpoint of further reducing the thermal conductivity, the layer having a heat ray absorbing function may be a resin film produced by kneading carbon black, antimony oxide, or barium sulfate.

From the viewpoint of further enhancing the thermal insulation properties, the substrate can have a layer composed of a material containing at least one selected from the group consisting of carbon graphite, aluminum, magnesium, silver, titanium, carbon black, metal sulfates, and antimony compounds. From the viewpoint of having high handling properties and enhancing the thermal insulation properties, the substrate may be an aluminum foil, an aluminum deposited film, a silver deposited film, or an antimony oxide containing film.

The substrate may have, on its surface of the side onto which the aerogel layer is provided, a primer layer for the purpose of an enhancement in adhesiveness with the aerogel layer. Examples of the material forming the primer layer include polyurethane resins, polyester resins, acrylic resins, and phenol resins. These resin layers may be a single layer or may be a multi-layer.

The thickness of the substrate is not particularly limited; from the viewpoint of the handling properties, the thickness can be 3 μm or more, may be 5 μm or more, or may be 7 μm or more. On the other hand, from the viewpoint of enhancing the thermal insulation properties, the thickness of the substrate can be 100 μm or less, may be 80 μm or less, or may be 50 μm or less. Namely, the thickness of the substrate can be 3 to 100 μm, may be 5 to 80 μm, or may be 7 to 50 μm.

<Method of Producing Aerogel Laminate>

The method of producing the aerogel laminate according to the Embodiment is not particularly limited, and the aerogel laminate according to the Embodiment can be produced by the following method, for example.

That is, the aerogel laminate according to the Embodiment can be produced by a production method mainly including: a resin layer forming step of forming a resin layer onto the substrate; a step of preparing a sol of producing a sol for forming an aerogel; an applying step of applying the sol obtained in the step of preparing a sol to the surface of the substrate onto which the resin layer is not provided, and drying the sol to form an aerogel layer; an aging step of aging the aerogel layer obtained in the applying step; a step of washing the aged aerogel layer and performing solvent exchange; and a drying step of drying the aerogel layer washed and subjected to solvent exchange (when necessary). The “sol” in the Embodiment refers to a state before a gelation reaction occurs where the silicon compound described above (as well as silica particles as necessary) is dissolved or dispersed in a solvent.

Each step of the production method for the aerogel laminate according to the Embodiment will be described below.

(Resin Layer Forming Step)

The resin layer forming step is a step where a resin coating solution obtained by mixing a resin component used for the resin layer mentioned above with an organic solvent is applied to the substrate and cured by drying to form the resin layer on the surface of the substrate. It is desirable that the adhesive force of the resin layer to the substrate be ensured.

The organic solvent is not particularly limited as long as the organic solvent is a solvent capable of forming a good coating on the substrate, and a solvent not reacting with the resin component contained in the coating solution for forming the resin layer may be used.

Examples of the organic solvent include hydrocarbon compounds, such as toluene, xylene and cyclohexane; ester compounds, such as ethyl acetate, n-butyl acetate and isobutyl acetate; ketone compounds, such as acetone, methyl ethyl ketone and methyl isobutyl ketone; and ether compounds, such as diethylene glycol dimethyl ether and dipropylene glycol dimethyl ether. These can be used singly, or in a combination of 2 or more thereof. Among these, it is preferred to use toluene from the viewpoint of the solubility and applicability of the resin.

As an application apparatus, a die coater, a comma coater, a bar coater, a kiss coater, a roll coater, or the like can be used, and is appropriately used according to the thickness of the resin layer. The coating after the coating solution for forming the resin layer is applied can be dried by heating or the like.

Although the drying temperature varies according to the amount of the solvent in the coating solution for forming the resin layer and the boiling point of the solvent, the drying temperature can be 50 to 200° C., for example, and may be 80 to 150° C. By controlling the drying temperature to be 50° C. or more, the drying of the resin layer can be performed in a shorter time, and by controlling the drying temperature to be 200° C. or less, the adhesiveness to the substrate is readily obtained.

Although the drying time varies according to the drying temperature, the drying time can be 0.2 to 10 minutes, for example, and may be 0.5 to 5 minutes. By controlling the drying time to be 0.2 minutes or more, the resin layer is readily formed, and by controlling the drying time to be 10 minutes or less, the adhesiveness to the substrate is readily obtained. The above drying condition can be appropriately set preliminarily by a simple test.

(Step of Preparing Sol)

The step of preparing a sol is a step of mixing the silicon compound mentioned above with a solvent containing silica particles in some cases to perform a hydrolysis reaction, and performing a sol gel reaction to obtain a semi-gelated sol coating solution. In this step, an acid catalyst may be further added in a solvent for promoting the hydrolysis reaction. Further, a surfactant, a thermally hydrolyzable compound, etc. may be also added in a solvent as disclosed in JP 5250900 B. Furthermore, a base catalyst may be added to promote the gelation reaction. The silica particles may be contained in the sol from the viewpoint of reducing the time taken in this step, and the applying step and the aging step described later to reduce the heating and drying temperatures.

The solvent is not particularly limited in the applying step described later as long as good coating properties are obtained; for example, water, or a mixed solution of water and alcohol can be used. Examples of an alcohol include methanol, ethanol, n-propanol, 2-propanol, n-butanol, 2-butanol, and t-butanol. Among these, water can be used because the surface tension is high and the volatility is low.

Examples of an acid catalyst include an inorganic acid, such as hydrofluoric acid, hydrochloric acid, nitric acid, sulfuric acid, sulfurous acid, phosphoric acid, phosphorous acid, hypophosphorous acid, bromic acid, chloric acid, chlorous acid, and hypochlorous acid; an acidic phosphate, such as acidic aluminum phosphate, acidic magnesium phosphate, and acidic zinc phosphate; and an organic carboxylic acid, such as acetic acid, formic acid, propionic acid, oxalic acid, malonic acid, succinic acid, citric acid, malic acid, adipic acid, and azelaic acid. Among them, as an acid catalyst for further improving the water resistance of an obtained aerogel layer, an organic carboxylic acid can be used, specific examples of the organic carboxylic acid include acetic acid, formic acid, propionic acid, oxalic acid or malonic acid, and the organic carboxylic acid may be acetic acid. They may be used singly, or in a combination of 2 or more thereof.

When an acid catalyst is used, a hydrolysis reaction of a silicon compound and a polysiloxane compound is promoted, and a sol may be obtained in a shorter time.

The addition amount of an acid catalyst with respect to the total amount of a silicon compound and a polysiloxane compound as 100 parts by mass may be 0.001 to 0.1 part by mass.

As a surfactant a nonionic surfactant, an ionic surfactant, etc. may be used. The surfactants may be used singly, or in a combination of 2 or more thereof.

As a nonionic surfactant, for example, a compound comprising a hydrophilic moiety such as polyoxyethylene and a hydrophobic moiety composed mainly of an alkyl group, or a compound comprising a hydrophilic moiety such as polyoxypropylene may be used. Examples of a compound comprising a hydrophilic moiety such as polyoxyethylene and a hydrophobic moiety composed mainly of an alkyl group include polyoxyethylene nonylphenyl ether, polyoxyethylene octylphenyl ether, and polyoxyethylene alkyl ether. Examples of a compound comprising a hydrophilic moiety such as polyoxypropylene include polyoxypropylene alkyl ether, and a block copolymer of polyoxyethylene and polyoxypropylene.

As an ionic surfactant, a cationic surfactant, an anionic surfactant, an amphoteric surfactant, and the like can be used. Examples of the cationic surfactant include cetyltrimethylammonium bromide and cetyltrimethylammonium chloride. Examples of an anionic surfactant include sodium dodecyl sulfonate. Examples of an amphoteric surfactant include an amino acid surfactant, a betaine surfactant, and an amine oxide surfactant. Examples of an amino acid surfactant include acylglutamic acid. Examples of a betaine surfactant include lauryldimethylaminoacetic acid betaine, and stearyldimethylaminoacetic acid betaine. Examples of an amine oxide surfactant include lauryldimethylamine oxide.

It is conceived that such a surfactant acts to suppress phase separation by reducing a difference in a chemical affinity between a solvent in a reaction system and a growing siloxane polymer in an applying step described below.

Although the addition amount of a surfactant depends on the type of a surfactant, and the type and amount of a silicon compound (a silicon compound group and a polysiloxane compound group), it may be for example 1 to 100 parts by mass with respect to the total amount of a silicon compound as 100 parts by mass, and may be also 5 to 60 parts by mass.

It is conceived that a thermally hydrolyzable compound generates a base catalyst by thermal hydrolysis to make a reaction solution basic, thereby promoting a sol-gel reaction. Therefore, there is no particular restriction on the thermally hydrolyzable compound, insofar as it is a compound able to make a reaction solution basic after hydrolysis, and examples thereof include urea; an acid amide, such as formamide, N-methylformamide, N,N-dimethylformamide, acetamide, N-methylacetamide and N,N-dimethylacetamide; and a cyclic nitrogen compound, such as hexamethylenetetramine Among them, especially urea is apt to achieve the above promotion effect.

There is no particular restriction on the addition amount of a thermally hydrolyzable compound, insofar as it is an amount sufficient to promote thoroughly a sol-gel reaction. For example, when urea is used as a thermally hydrolyzable compound, its addition amount may be 1 to 200 parts by mass with respect to the total amount of a silicon compound (a silicon compound group and a polysiloxane compound group) as 100 parts by mass, and may be also 2 to 150 parts by mass. By controlling the addition amount to be 1 part by mass or more, excellent reactivity may be obtained more easily, and by controlling the addition amount to be 200 parts by mass or less, precipitation of a crystal and decrease in a gel density may be suppressed more easily.

Hydrolysis in a step of preparing a sol may be carried out, for example, in a temperature environment of 20 to 60° C. for 10 min to 24 hours, or may be carried out in a temperature environment of 50 to 60° C. for 5 min to 8 hours, subject to the type and quantity of a silicon compound, a polysiloxane compound, a silica particle, an acid catalyst, a surfactant, or the like in a mixture liquid. By this means, hydrolyzable functional groups in a silicon compound and a polysiloxane compound are hydrolyzed adequately, so that a hydrolysis product of a silicon compound and a hydrolysis product of a polysiloxane compound can be obtained more surely.

In a case where a thermally hydrolyzable compound is added into a solvent, the temperature environment of a step of preparing a sol may be adjusted to a temperature at which hydrolysis of the thermally hydrolyzable compound is suppressed and gelation of a sol is suppressed. Such a temperature is optional insofar as hydrolysis of a thermally hydrolyzable compound is suppressed at the temperature. For example, in a case where urea is used as a thermally hydrolyzable compound, the temperature environment of a step of preparing a sol may be 0 to 40° C., or also 10 to 30° C.

Examples of a base catalyst include an alkali metal hydroxide, such as lithium hydroxide, sodium hydroxide, potassium hydroxide, and cesium hydroxide; an ammonium compound, such as ammonium hydroxide, ammonium fluoride, ammonium chloride, and ammonium bromide; a basic sodium phosphate salt, such as sodium metaphosphate, sodium pyrophosphate, and sodium polyphosphate; an aliphatic amine, such as allylamine, diallylamine, triallylamine, isopropylamine, diisopropylamine, ethylamine, diethylamine, triethylamine, 2-ethylhexylamine, 3-ethoxypropylamine, diisobutylamine, 3-(diethylamino)propylamine, di-2-ethylhexylamine, 3-(dibutylamino)propylamine, tetramethylethylenediamine, t-butylamine, sec-butylamine, propylamine, 3-(methylamino)propylamine, 3-(dimethylamino)propylamine, 3-methoxyamine, dimethylethanolamine, methyldiethanolamine, diethanolamine, and triethanolamine; and a nitrogen-containing heterocyclic compound, such as morpholine, N-methylmorpholine, 2-methylmorpholine, piperazine and its derivative, piperidine and its derivative, and imidazole and its derivative. Among them, ammonium hydroxide (ammonia water) is superior, because it has high volatility so that it hardly remains in an aerogel layer after drying hard to impair the water resistance, and further because it is economical. The base catalyst may be used singly, or in a combination of 2 or more thereof.

By using a base catalyst, a dehydration condensation reaction and/or a dealcoholization condensation reaction, of any of silicon compound (polysiloxane compound group and silicon compound group) and a silica particle in a sol may be promoted such that gelation of the sol is performed in a shorter time. Especially ammonia is highly volatile and hardly remains in an aerogel layer, therefore when ammonia is used as a base catalyst, an aerogel layer with improved water resistance may be obtained.

The addition amount of a base catalyst may be 0.5 to 5 parts by mass, or may be also 1 to 4 parts by mass with respect to the total amount of silicon compound (polysiloxane compound group and silicon compound group) as 100 parts by mass. When the addition amount of a base catalyst is 0.5 part by mass or more, gelation can be carried out in a shorter time, and when the addition amount of a base catalyst is 5 parts by mass or less, decrease in water resistance may be further suppressed.

The sol needs to be in a semi-gelated state in the sol gel reaction of the step of preparing a sol for the purpose of obtaining good coating properties in the applying step described later. It is preferred that this reaction be performed in a tightly closed container such that the solvent and the base catalyst do not volatilize. Although the gelation temperature varies according to the types and the amounts of the silicon compound, the polysiloxane compound, the silica particles, the acid catalyst, the surfactant, base catalyst, and the like in the sol, the gelation temperature can be 30 to 90° C., and may be 40 to 80° C. If the gelation temperature is controlled to be 30° C. or more, the gelation can be performed in a shorter time, and if the gelation temperature is controlled to be 90° C. or less, rapid gelation can be suppressed.

Although the time for the sol gel reaction varies according to the gelation temperature, the gelation time can be shortened compared to the sol used in conventional aerogels in the case where the silica particles are contained in the sol in the Embodiment. This reason is inferred as follows: the silanol groups or reactive groups in silicon compound (polysiloxane compound group and silicon compound group) in the sol form hydrogen bonds or chemical bonds with the silanol groups in the silica particles. The gelation time can be 10 to 360 minutes, and may be 20 to 180 minutes. By controlling the gelation time to be 10 minutes or more, the viscosity of the sol is enhanced to readily obtaining good applicability in the applying step described later, and by controlling the gelation time to be 360 minutes or less, the complete gelation of the sol is suppressed to readily obtain the adhesiveness to the substrate which is a non-aerogel layer.

(Applying Step)

The applying step is a step of applying the semi-gelated sol coating solution obtained in the above step of preparing a sol to a substrate to form an aerogel layer. Specifically, by applying the above sol coating solution to the substrate, and drying sol coating solution, the sol coating solution is gelated to form an aerogel layer on the surface of the substrate. It is desirable that the adhesive force of the aerogel layer to the substrate be ensured. The aerogel laminate according to the Embodiment can be wound into a roll to be stored.

As an applicator, a die coater, a comma coater, a bar coater, a kiss coater, a roll coater, or the like can be used, and is appropriately used according to the thickness of the aerogel layer. The coating after the sol coating solution is applied can be dried by heating or the like.

The drying of the sol coating solution after applied to the substrate can be performed on the condition such that the moisture content of the aerogel layer after drying is 10% by mass or more, and the drying may be performed on, for example, the condition such that the moisture content of the aerogel layer after drying is 50% by mass or more. If the moisture content of the aerogel layer is controlled to be 10% by mass or more, the adhesiveness to the substrate is readily obtained.

Although the drying temperature varies according to the moisture content or the amount of the organic solvent in the sol coating solution and the boiling point of the organic solvent, the drying temperature can be 50 to 150° C., for example, and may be 60 to 120° C. By controlling the drying temperature to be 50° C. or more, the gelation can be performed in a shorter time, and by controlling the drying temperature to be 150° C. or less, the adhesiveness to the substrate is readily obtained.

Although the drying time varies according to the drying temperature, the drying time can be 0.2 to 10 minutes, for example, and may be 0.5 to 8 minutes. By controlling the drying time to be 0.2 minutes or more, the aerogel layer is readily formed, and by controlling the drying time to be 10 minutes or less, the adhesiveness to the substrate is readily obtained. The above drying condition can be appropriately set preliminarily by a simple test.

Moreover, a separator can be further laminated on the surface of the aerogel layer opposite to the substrate. By laminating the separator, the transfer of the above aerogel surface to the rear surface of the substrate (the resin layer) when the aerogel laminate is wound into a roll can be further prevented. In the case where the separator is laminated, in the applying step, for example, the separator may be laminated after the sol coating solution is applied, or may be laminated after the coating formed of the sol coating solution is dried. Examples of the separator include resin films composed of resins such as polyolefin, polyester, polycarbonate and polyimide, metal foils such as copper foil and aluminum foil, and releasing paper. Among these, a resin film can be used from the viewpoint of keeping the moisture content of the aerogel layer high, if the separator is laminated after the sol coating solution is applied. The separator may be subjected to a releasing treatment such as a matting treatment or a corona treatment.

(Aging Step)

The aging step is a step of aging the aerogel layer, which is formed by the above applying step, through heating. In this step, from the viewpoint of suppressing a reduction in the adhesiveness of the aerogel layer to the substrate, it is preferred that the aerogel layer be aged such that the moisture content of the aerogel layer be 10% by mass or more, and it is more preferred that the aerogel layer be aged such that the moisture content of the aerogel layer be 50% by mass or more. The aging method is not particularly limited as long as the above range is satisfied; examples thereof include a method of aging an aerogel laminate in a sealed atmosphere, and a method of aging using a thermo-hygrostat which can suppress a reduction in moisture content caused by heating.

The aging temperature can be 40 to 90° C., for example, and may be 50 to 80° C. By controlling the aging temperature to be 40° C. or more, the aging time can be shortened. By controlling the aging temperature to be 90° C. or less, a reduction in the moisture content can be suppressed.

The aging time can be 1 to 48 hours, for example, and may be 3 to 24 hours. By controlling the aging time to be one hour or more, further high thermal insulation properties can be obtained, and by controlling the aging time to be 48 hours or less, high adhesiveness to the substrate can be obtained.

(Step of Washing and Solvent Exchange)

The washing and solvent exchange step has a step of washing the aerogel laminate obtained in the above aging step (washing step) and a step of exchanging the solvent for a solvent suitable for the drying step described later (solvent exchange step). The method of washing and solvent exchange is not particularly limited. Although the washing and solvent exchange step can be implemented in the form of performing only the solvent exchange step without performing the step of washing the aerogel laminate, the aerogel layer after aging may be washed from the viewpoint of reducing impurities such as unreacted substances and by-products in the aerogel layer to enable production of an aerogel laminate having higher purity.

In the washing step, the aerogel layer in the aerogel laminate obtained in the above aging step can be repeatedly washed using water or an organic solvent.

As an organic solvent, various organic solvents, such as methanol, ethanol, 1-propanol, 2-propanol, 1-butanol, acetone, methyl ethyl ketone, 1,2-dimethoxyethane, acetonitrile, hexane, toluene, diethyl ether, chloroform, ethyl acetate, tetrahydrofuran, methylene chloride, N,N-dimethylformamide, dimethyl sulfoxide, acetic acid and formic acid, may be used. The organic solvents may be used singly, or in a combination of 2 or more thereof.

In a solvent exchange step described below, a low surface tension solvent may be used for suppressing contraction of an aerogel layer by drying. However, a low surface tension solvent has in general extremely low mutual solubility with water. Therefore, when a low surface tension solvent is used in a solvent exchange step, it is preferred that the organic solvent used in a washing step is a hydrophilic organic solvent having high mutual solubility with respect to both water and the low surface tension solvent. In this regard, a hydrophilic organic solvent used in a washing step can perform a function of preliminary exchange for a solvent exchange step. For this reason, among these organic solvents described above, hydrophilic organic solvents such as methanol, ethanol, 2-propanol, acetone, and methyl ethyl ketone can be used; furthermore, methanol, ethanol or methyl ethyl ketone may be used from the viewpoint of economy.

The amount of water or an organic solvent used in a washing step can be an amount enough to exchange the solvent in the aerogel layer, and to wash; the solvent can be used in an amount 3 to 10 times the volume of the aerogel layer. Washing may be repeated until the water content in an aerogel layer after washing reaches 10 mass % or less.

The temperature in a washing step may be not higher than the boiling point of a solvent used for washing, and for example in a case where methanol is used, it may be between approx. 30 and 60° C.

To suppress contraction of the aerogel layer in the drying step described later, the solvent contained in the washed aerogel layer is exchanged for a predetermined exchange solvent in the solvent exchange step. In this case, the exchange efficiency may be enhanced by raising the temperature. Specific examples of an exchange solvent, in a case where drying is performed in a step of drying at the atmospheric pressure and at a temperature less than a critical point of a solvent used for drying, include a low surface tension solvent described below. On the other hand, in the case where supercritical drying is performed, ethanol, methanol, 2-propanol, dichlorodifluoromethane or carbon dioxide may be used singly or in combinations of 2 or more as the exchange solvent, for example.

Examples of a low surface tension solvent include a solvent having a surface tension of 30 mN/m or less at 20° C. The surface tension may be also 25 mN/m or less, or even 20 mN/m or less. Examples of a low surface tension solvent include an aliphatic hydrocarbon, such as pentane (15.5), hexane (18.4), heptane (20.2), octane (21.7), 2-methylpentane (17.4), 3-methylpentane (18.1), 2-methylhexane (19.3), cyclopentane (22.6), cyclohexane (25.2), and 1-pentene (16.0); an aromatic hydrocarbon, such as benzene (28.9), toluene (28.5), m-xylene (28.7), and p-xylene (28.3); a halogenated hydrocarbon, such as dichloromethane (27.9), chloroform (27.2), carbon tetrachloride (26.9), 1-chloropropane (21.8), and 2-chloropropane (18.1); an ether, such as ethyl ether (17.1), propyl ether (20.5), isopropyl ether (17.7), butyl ethyl ether (20.8), and 1,2-dimethoxyethane (24.6); a ketone, such as acetone (23.3), methyl ethyl ketone (24.6), methyl propyl ketone (25.1), and diethyl ketone (25.3); and an ester, such as methyl acetate (24.8), ethyl acetate (23.8), propyl acetate (24.3), isopropyl acetate (21.2), isobutyl acetate (23.7), and ethyl butyrate (24.6). A number in parentheses means a surface tension at 20° C. in unit [mN/m]. Among them, an aliphatic hydrocarbon (such as hexane and heptane) has a low surface tension, and is superior in work environmental property. Further, when a hydrophilic organic solvent, such as acetone, methyl ethyl ketone and 1,2-dimethoxyethane, among the above solvents is used, it may have also a function of an organic solvent for the washing step. Further, among the above solvents, a solvent with a boiling point at a normal pressure of 100° C. or less may be also used, because drying in a step of drying described below is easy. The solvents may be used singly, or in a combination of 2 or more thereof.

The amount of the solvent used in the solvent exchange step can be an amount such that the solvent in the washed aerogel layer can be sufficiently exchanged, and the solvent can be used in an amount 3 to 10 times the volume of the aerogel layer.

The temperature in a solvent exchange step may be not higher than the boiling point of a solvent used for exchange, and for example in a case where heptane is used, it may be between approx. 30 and 60° C.

In the Embodiment, in the case where the sol contains silica particles, the solvent exchange step is not always essential as described above. A mechanism is conjectured as follows. According to the Embodiment a silica particle functions as a support for a three-dimensional network skeleton of the aerogel, and as a result, the skeleton is supported such that contraction of a gel in a step of drying is suppressed. Consequently, it is conceivable that a gel can be subjected to a step of drying as it is without exchanging a solvent used for washing. As described above, in the Embodiment, a step of washing and solvent exchange through a step of drying may be simplified in the case where the sol contains silica particles.

Moreover, in the case where the separator is laminated in the applying step, from the viewpoint of enhancing the washing and solvent exchange efficiency of the aerogel layer, the separator may be removed before the washing step, and may be again laminated after the solvent exchange step.

(Step of Drying)

In a step of drying, an aerogel layer subjected to washing and (according to need) solvent exchange as described above is dried. Thereby, the final aerogel laminate can be obtained.

The drying method is not particularly limited, and known normal pressure drying, supercritical drying, or freeze-drying can be used. Among these, normal pressure drying or supercritical drying can be used from the viewpoint of readily producing an aerogel layer having low density. Also, from the viewpoint that production at a low cost is possible, normal pressure drying may be applied. “Normal pressure” in the Embodiment means 0.1 MPa (atmospheric pressure).

The aerogel laminate according to the Embodiment can be obtained by drying the aerogel layer subjected to washing and (when necessary) solvent exchange at a temperature less than the critical point of the solvent used in drying under atmospheric pressure. Although the drying temperature varies according to the type of the exchanged solvent (the solvent used in washing in the case where solvent exchange is not performed) or the heat resistance of the substrate, the drying temperature can be 60 to 180° C., and may be 90 to 150° C. Although the drying time varies according to the volume of the aerogel layer and the drying temperature, the drying time can be 2 to 48 hours. In the Embodiment, the drying can be accelerated by applying pressure in a range not inhibiting the productivity.

Moreover, pre-drying may be performed before the drying step in the aerogel laminate according to the Embodiment from the viewpoint of enhancing the drying efficiency in normal pressure drying. The pre-drying method is not particularly limited. The pre-drying temperature can be 60 to 180° C., and may be 90 to 150° C. Moreover, the pre-drying time can be 1 to 30 minutes. The aerogel laminate obtained by such pre-drying can be further dried in the drying step.

In the case where the separator is laminated in the washing and solvent exchange step, from the viewpoint of drying efficiency and transportation efficiency, the separator can be removed before pre-drying, and be again laminated after pre-drying. Moreover, in the case where the washing and solvent exchange step to the drying step are continuously performed, the separator can be removed before the washing step, and be again laminated after pre-drying.

An aerogel laminate according to the Embodiment may be obtained also by conducting supercritical drying on an aerogel laminate subjected to washing, and (according to need) solvent exchange. Supercritical drying may be conducted by a publicly known technique. Examples of a method for supercritical drying include a method by which a solvent is removed at a temperature and a pressure not lower than the critical point of a solvent contained in an aerogel layer. Alternatively, examples of a method for supercritical drying include a method by which an aerogel layer is immersed in liquefied carbon dioxide for example under conditions of approx. 20 to 25° C., and 5 to 20 MPa to exchange all or part of the solvent contained in an aerogel layer for carbon dioxide having a lower critical point than that of the solvent, and then carbon dioxide alone, or a mixture of carbon dioxide and the solvent is removed.

[Thermal Insulation Material]

The thermal insulation material according to the Embodiment includes at least one of the aerogel laminates described above, and has high thermal insulation properties and high flexibility. It should be noted that the aerogel laminate obtained by the above production method for the aerogel laminate can be used as a thermal insulation material as it is (or processed into a predetermined shape when necessary). The thermal insulation material may be a thermal insulation material in which a plurality of the aerogel laminates are laminated.

The aerogel laminate according to the Embodiment has at least one structure in which the aerogel layer, the substrate and the resin layer are laminated in the thickness direction. Because the formation of the aerogel into a thin film, which has difficulty in handling properties in the related art, is enabled, the aerogel laminate according to the Embodiment can be used as a thermal insulation material having high thermal insulation properties and high flexibility, and a reduction in thickness of the thermal insulation material can be attained.

Because of such advantages, the aerogel laminate according to the Embodiment can be used in applications as a thermal insulation material in the cryogenic field (superconductivity, cryogenic container, and the like), in the universe field, the building field, the automobile field, household electrical appliances, the semiconductor field, and industrial facilities, etc. Moreover, the aerogel laminate according to the Embodiment can be used, besides applications as a thermal insulation material, as a water-repellant sheet, a sound absorbing sheet, a deadening sheet, and a catalyst carrying sheet.

### EXAMPLES

Next, the present invention will be described in more detail by way of Examples below, but these Examples will not be limiting the present invention in any sense.

[Production of Coating Solution for Forming Resin Layer]

### (Coating Solution 1)

A long chain alkyl-containing resin (made by Lion Specialty Chemicals Co., Ltd., product name: “PEELOIL 1010”) and toluene were formulated such that the solid content becomes 1.5% by mass, and stirred for 2 minutes to produce coating solution 1.

(Coating Solution 2)

A polyol compound (made by Hitachi Chemical Co., Ltd., product name: “Hitaloid 3204EB-1”, hydroxy value of 30 KOHmg/g, viscosity of 4030 mPa·s, weight average molecular weight of 47000), a polyisocyanate compound (made by Asahi Kasei Corporation, product name: “DURANATE E405-80T”, NCO content rate of 7% by mass, viscosity of 252 Pa·s) and toluene were formulated such that the equivalent ratio of hydroxy group/isocyanate group becomes 0.5:1 and the solid content becomes 1.5% by mass, and stirred for 2 minutes to give a resin solution containing a polyurethane resin. Next, a silicone resin (made by BYK-Chemie, product name: “BYK333”) was formulated into the obtained resin solution such that the amount of the silicone resin becomes 0.5% by mass relative to the polyurethane resin, and stirred for 2 minutes to produce coating solution 2.

(Coating Solution 3)

“Hitaloid 3204EB-1”, “DURANATE E405-80T” and toluene were formulated such that the equivalent ratio of hydroxy group/isocyanate group becomes 1:1 and the solid content becomes 1.5% by mass, and stirred for 2 minutes to give a resin solution containing a polyurethane resin. Next, a siloxane modified resin (made by KYOEI KAGAKU K.K., product name: “GL-03”) was formulated into the obtained resin solution such that the amount of the siloxane modified resin becomes 0.5% by mass relative to the polyurethane resin, and stirred for 2 minutes to produce coating solution 3.

[Production of Sol Coating Solution for Forming Aerogel Layer]

### (Synthesis of Polysiloxane Compound A)

In a 1 L 3-necked flask including a stirrer, a thermometer, and a Dimroth condenser, 100.0 parts by mass of hydroxy terminated dimethylpolysiloxane (made by Momentive Performance Materials Inc., product name: “XC96-723”), 181.3 parts by mass of methyltrimethoxysilane, and 0.50 parts by mass of t-butylamine were mixed to be reacted at 30° C. for 5 hours. Subsequently, this reaction solution was heated under a reduced pressure of 1.3 kPa at 140° C. for 2 hours to remove volatile components, yielding a modified polysiloxane compound having two alkoxy functional groups at both ends having a structure represented by the above Formula (B) (Polysiloxane compound A).

(Sol Coating Solution)

100.0 parts by mass of PL-2L (made by FUSO CHEMICAL CO., LTD., product name, average primary particle diameter: 20 nm, solid content: 20% by mass) as a silica particle-containing raw material, 100.0 parts by mass of water, 0.10 parts by mass of acetic acid as an acid catalyst, 20.0 parts by mass of hexadecyltrimethylammonium bromide (made by Wako Pure Chemical Industries, Ltd., hereinafter, abbreviated to “CTAB”) as a ionic surfactant, and 120.0 parts by mass of urea as a thermally hydrolyzable compound were mixed, and to this mixture, 60.0 parts by mass of methyltrimethoxysilane (made by Shin-Etsu Chemical Co., Ltd., hereinafter, abbreviated to “MTMS”) and 20.0 parts by mass of dimethoxydimethylsilane (made by Tokyo Chemical Industry Co., Ltd., hereinafter, abbreviated to “DMDMS”) as a silicon compound, and 20.0 parts by mass of Polysiloxane compound A as a polysiloxane compound, were added to be reacted at 25° C. for 1 hour. Subsequently, a sol gel reaction was performed at 80° C. for 15 minutes to obtain Sol coating solution.

### Example 1

By using a film applicator (made by TESTER SANGYO CO., LTD., product name: “PI-1210”), Coating solution 1 was applied to a double-sided aluminum deposited PET film measuring 1500 mm (length)×1000 mm (width)×12 μm (thickness) (made by Hitachi AIC Inc., product name: “VM-PET”) as a substrate such that the thickness after drying was 1 μm, and was dried at 120° C. for 1 minute to obtain an substrate having Resin layer 1.

Next, by using a film applicator, Sol coating solution described above was applied to the surface of the above substrate onto which Resin layer 1 was not provided such that the thickness after gelation was 40 μm, and was dried at 90° C. for 2 minutes to obtain an aerogel laminate having a gel-like aerogel layer. Subsequently, the aerogel laminate obtained was placed in a tightly closed container, and was aged at 60° C. for 3 hours.

Next, the aged aerogel laminate was washed with 2000 mL of water over 2 minutes; then the laminate was immersed in 2000 mL of methanol for 2 minutes to perform solvent exchange. This washing operation was performed twice while methanol was replaced with new one. The aerogel laminate subjected to washing and solvent exchange was dried at 120° C. for 1 hour to obtain Aerogel laminate 1 having structures represented by the above formulae (4) and (5).

### Example 2

Aerogel laminate 2 was obtained in the same manner as in Example 1 except that Coating solution 2 was used for forming a resin layer.

### Example 3

Aerogel laminate 3 was obtained in the same manner as in Example 1 except that Coating solution 2 was used for forming a resin layer.

### Comparative Example 1

By using a film applicator, Sol coating solution described above was applied to a double-sided aluminum deposited PET film measuring 1500 mm (length)×1000 mm (width)×12 μm (thickness) as a substrate such that the thickness after gelation was 40 μm, and was dried at 90° C. for 1.5 minutes to obtain an aerogel laminate having a gel-like aerogel layer. Subsequently, the aerogel laminate obtained was placed in a tightly closed container, and was aged at 60° C. for 3 hours.

Subsequently, the aged aerogel laminate was washed with 2000 mL of water for 2 minutes; then the laminate was immersed in 2000 mL of methanol for 2 minutes to perform solvent exchange. This washing operation was performed twice while methanol was replaced with new one. The aerogel laminate subjected to washing and solvent exchange was dried at 120° C. for 1 hour to obtain Aerogel laminate 4.

### Comparative Example 2

A double-sided aluminum deposited PET film measuring 1500 mm (length)×1000 mm (width)×12 μm (thickness) as a substrate and an E glass cloth (made by Nitto Boseki Co., Ltd.) measuring 1500 mm (length)×1000 mm (width)×42 μm (thickness) (IPC specification: 1078) as a thermal insulation layer were laminated to obtain a laminated thermal insulation material.

[Evaluation of Transfer]

It was verified visually whether the transfer to the resin layer or the substrate was present or not. In particular, the aerogel laminate before the aging step was cut into 10 cm×10 cm, and 5 pieces were stacked and placed in an aluminum pouch, sealed therein with a vacuum sealer, and aged at 60° C. for 3 hours. After the aging step, the aerogel laminate was taken out, and it was verified visually whether the transfer of the aerogel to the resin layer or the substrate that was in contact with the aerogel layer was present or not. When the aerogel layer was transferred to the resin layer or the substrate, or was peeled off from the substrate, it was determined to be “observed,” and if not, “not observed.”

[Evaluation of Thermal Insulation Performance]

The aerogel laminates obtained in Examples and Comparative Examples, as well as the laminated thermal insulation material obtained in Comparative Example, were measured and evaluated according to the following conditions.

(1) Preparation of Liquid Nitrogen Container for Evaluating Thermal Insulation Properties

The aerogel laminates and the laminated thermal insulation materials were processed into Sheet A having a size of 606 mm (length)×343 mm (width), Sheet B having a size of 612 mm (length)×362 mm (width), Sheet C having a size of 618 mm (length)×380 mm (width), Sheet D having a diameter of 105 mm, Sheet E having a diameter of 112 mm, and Sheet F having a diameter of 118 mm, respectively.

Next, as sheets for an outer periphery of a liquid nitrogen container, Sheet A10 in which 10 layers of Sheet A were laminated, Sheet B10 in which 10 layers of Sheet B were laminated, and Sheet C10 in which 10 layers of Sheet C were laminated were produced, respectively, such that resin layers or substrates adjacent through an aerogel layer or a thermal insulation layer were not in direct contact with each other. In the same manner as above, as upper and lower sheets for a liquid nitrogen container, Sheet D10 in which 10 layers of Sheet D were laminated, Sheet E10 in which 10 layers of Sheet E were laminated, and Sheet F10 in which 10 layers of Sheet F were laminated were produced, respectively.

A liquid nitrogen container having a height of 600 mm and a diameter of 100 mm was prepared; Sheet A10 was disposed on the side surface, and Sheet D10 was disposed on each of the upper and lower sides of the liquid nitrogen container; the sheets were wrapped around the liquid nitrogen container. Next, Sheet B10 was disposed on Sheet A10 and Sheet E10 was disposed on Sheet D10; furthermore, Sheet C10 was disposed on Sheet B10 and Sheet F10 was disposed on Sheet E10 to obtain a liquid nitrogen container for evaluating thermal insulation properties in which 30 layers of the aerogel laminate or the laminated thermal insulation material were laminated. The connection portions between the sheets on the side surfaces and the upper and lower sheets were bonded with an aluminum tape.

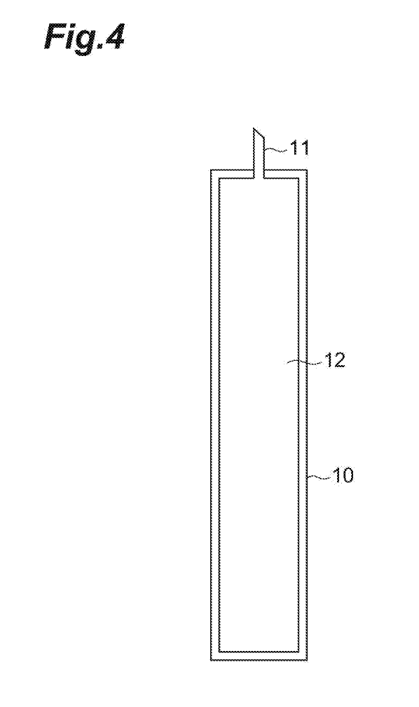

FIG. 4 is a cross-sectional view schematically illustrating the structure of the liquid nitrogen container for evaluating thermal insulation properties in which a thermal insulation material 10 is wrapped around a liquid nitrogen container 12. The thermal insulation material 10 composed of 30 layers of the aerogel laminate or the laminated thermal insulation material is laminated on the liquid nitrogen container 12 having an inlet 11 so as to cover the outer periphery.

(2) Measurement of Thickness of Thermal Insulation Material

The total thickness D₃₀ (mm) of the thermal insulation material 10 disposed on the outer periphery of the liquid nitrogen container 12 was calculated from the following expression:

D₃₀=D_{c}/2−50.0

where D_{c} (mm) represents the diameter of the liquid nitrogen container after 30 layers of the aerogel laminated sheet or the laminated thermal insulation material are wrapped around the container.

(3) Thermal Insulation Performance (Heat Flux)

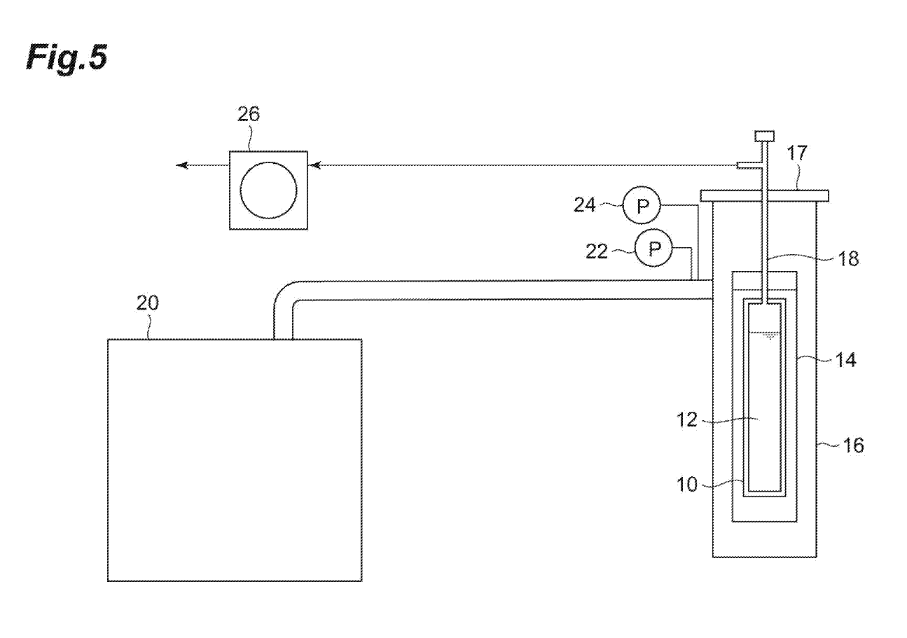

The thermal insulation performance was measured using the liquid nitrogen container for evaluating thermal insulation properties. A schematic view of the thermal insulation performance tester is illustrated in FIG. 5. First, the liquid nitrogen container 12 having the thermal insulation material 10 wrapped therearound was placed in a thermostat 14 set at 283 K, and the thermostat was placed in a vacuum container 16. Next, the vacuum container 16 was evacuated with a turbomolecular pump 20, and the vacuum pressure inside the vacuum container 16 was measured with a Pirani vacuum gauge 22 and an ion vacuum gauge 24. The turbomolecular pump 20 was operated, and it was checked that the Pirani vacuum gauge 22 indicated a vacuum pressure of 4×10⁻¹ Pa or less; then, the vacuum pressure was measured with the ion vacuum gauge 24, and evacuation was performed for 7 days until the pressure of the vacuum container 16 reached 1×10⁻² Pa or less. Subsequently, after liquid nitrogen was poured into the liquid nitrogen container 12 placed in the vacuum container 16, the heat flux q passing through the thermal insulation material 10 when it was verified that the temperature of a neck pipe 18 and the flow rate of evaporated nitrogen gas had approximately constant values and were in a stationary state was calculated.

The evaporating gas mass flow rate in (kg/s) of liquid nitrogen was determined from the following expression (I).

[Expression 1]

m=ρ_{g,T}×V_{g,T} (1)

In the expression (I), ρ_{g,T} represents the gas density (kg/m³) at room temperature; V_{g,T} represents the gas flow rate (m³/s) at room temperature measured from the output of a wet flow meter 26 and the temperature inside the wet flow meter 26.

Next, the sum of the radiant heat quantity Qᵣ (W) coming through the thermal insulation material 10 and the conductive heat Q_{c} (W) from the neck pipe 18 connecting a flange 17 to the liquid nitrogen container 12 was determined from the following expression (II).

$$\begin{matrix}[ Expression 2 ] & \\ {Q}_{r} + {Q}_{c} = \frac{m \times L}{( 1 - \frac{{ρ}_{g , s}}{{ρ}_{l , s}} )} & ( II )\end{matrix}$$

In the expression (II), L represents the evaporative latent heat (J/kg) of liquid nitrogen, ρ_{g,S} represents the nitrogen gas density (kg/m³) at a saturated temperature under atmospheric pressure, and ρ_{l,S} represents the liquid nitrogen density (kg/m³).

Moreover, Q_{c} was determined from the following expression (III).

$$\begin{matrix}[ Expression 3 ] & \\ {Q}_{c} = ( \frac{{A}_{s}}{{L}_{c}} {\int }_{{T}_{l}}^{{T}_{h}} {λ}_{sus} dT ) \times φ & ( III )\end{matrix}$$

In the expression (III), the expression in the brackets ( ) represents the conductive heat of the neck pipe 18, Aₛ (m²) represents the cross-sectional area of the neck pipe 18, L_{c} (in) represents the length of the neck pipe 18, Tₕ (K) represents a high temperature, T₁ (K) represents a low temperature, and λₛᵤₛ (W/(m·K)) represents the thermal conductivity of stainless steel. The conductive heat of the neck pipe 18 is related with the coefficient of the efficiency ϕ because heat is lost from the surface of the neck pipe 18 due to heat conduction of evaporating gas.

The efficiency ϕ was determined from the following expression (IV).

$$\begin{matrix}[ Expression 4 ] & \\ φ = \frac{ln ( 1 + {C}_{p} ( {T}_{h} - {T}_{l} ) / L )}{{C}_{p} ( {T}_{h} - {T}_{l} ) / L )} & ( IV )\end{matrix}$$

In the expression (IV), Cₚ (J/(kg·K)) represents the specific heat. In this evaluation, the value of Aₛ above is 0.243×10⁻⁴ (m²), and the value of L above is 199000 (J/kg).

The heat flux q (W/m²) passing through the aerogel laminate and the laminated thermal insulation material was determined from the following expression (V). The measurement of the heat flux was performed three times, and the average value was defined as the heat flux in this evaluation.

[Expression 5]

q=Qᵣ/Aᵣ (V)

In the expression (V), Aᵣ (m²) represents the surface area of the liquid nitrogen container, and the value is 0.2041 (m²).

The layer configuration, whether the transfer of the aerogel layer was present or not, and the evaluation of thermal insulation properties for the aerogel laminate and the laminated thermal insulation material obtained in each Example and Comparative Example are shown in Table 1.

TABLE 1

| | | | Thermal insulation | |
|---|---|---|---|---|
| | | | properties | |
| | | | Thick- | Heat |
| | | | ness | flux |
| | Resin layer | Transfer | (mm) | (W/m²) |
| Example 1 | Long chain alkyl- | Not | 6.0 | 0.76 |
| | containing resin | observed | | |
| Example 2 | Silicone | Not | 5.9 | 0.75 |
| | resin/ | observed | | |
| | polyurethane | | | |
| | resin | | | |
| Example 3 | Siloxane | Not | 6.0 | 0.76 |
| | modified resin/ | observed | | |
| | polyurethane | | | |
| | resin | | | |
| Comparative | — | Observed | 5.9 | 0.75 |
| Example 1 | | | | |
| Comparative | — | — | 9.5 | 1.05 |
| Example 2 | | | | |

It can be verified from Table 1 that the aerogel laminates made in Examples have superior thermal insulation properties and enable a reduction in thickness of the thermal insulation material, while being able to reduce the transfer and exfoliation of the aerogel layer, by providing a resin layer on the rear surface of the substrate, when a plurality of aerogel laminates are stacked.

### REFERENCE SIGNS LIST

1 . . . resin layer, 2 . . . substrate, 3 . . . aerogel layer, 10 . . . thermal insulation material, 11 . . . inlet, 12 . . . liquid nitrogen container, 14 . . . thermostat, 16 . . . vacuum container, 17 . . . flange, 18 . . . neck pipe, 20 . . . turbomolecular pump, 22 . . . Pirani vacuum gauge, 24 . . . ion vacuum gauge, 26 . . . wet flow meter, L . . . circumscribed rectangle, P . . . silica particle.

1. An aerogel laminate having a structure in which a resin layer, a substrate and an aerogel layer are laminated in this order.

2. The aerogel laminate according to claim 1, wherein the resin layer includes at least one resin selected from the group consisting of a silicone resin, a fluorine resin, a polyolefin resin, an alkyd resin, a long chain alkyl-containing resin and a siloxane modified resin.

3. The aerogel laminate according to claim 1, wherein the substrate has a heat ray reflective function or a heat ray absorbing function.

4. The aerogel laminate according to claim 1, wherein the aerogel layer is a layer containing an aerogel having a structure derived from polysiloxane.

5. The aerogel laminate according to claim 1, wherein the aerogel layer is a layer composed of a dry product of a wet gel that is a condensation product of a sol containing at least one selected from the group consisting of a silicon compound having a hydrolyzable functional group or a condensable functional group, and a hydrolysis product of the silicon compound having a hydrolyzable functional group.

6. The aerogel laminate according to claim 5, wherein the sol further contains silica particles.

7. The aerogel laminate according to claim 6, wherein an average primary particle diameter of the silica particles is 1 to 500 nm.

8. The aerogel laminate according to claim 1, wherein the substrate has a layer composed of a material comprising at least one selected from the group consisting of carbon graphite, aluminum, magnesium, silver, titanium, carbon black, metal sulfates, and antimony compounds.

9. The aerogel laminate according to claim 1, wherein the substrate is an aluminum foil, an aluminum deposited film, a silver deposited film, or an antimony oxide containing film.

10. The aerogel laminate according to claim 1, wherein the substrate is an aluminum foil or an aluminum deposited film.

11. A thermal insulation material including the aerogel laminate according to claim 1.
